(19) United States
(12) Patent Application Publication
(10) Pub. No.: US 2026/0333422 A1
(43) Pub. Date: Oct. 22, 2026

(54) Multi-Channel Access during Unavailability Period

(71) Applicant: Ofinno, LLC, Reston, VA (US)

(72) Inventors: Tuncer Baykas, Reston, VA (US); Jeongki Kim, Fairfax, VA (US); Esmael Hejazi Dinan, McLean, VA (US); Leonardo Alisasis Lanante, Reston, VA (US); Serhat Erkucuk, Reston, VA (US)

(73) Assignee: Ofinno, LLC, Reston, VA (US)

(21) Appl. No.: 19/690,195

(22) Filed: May 28, 2026

Related U.S. Application Data
(63) Continuation of application No. PCT/US2025/043440, filed on Aug. 26, 2025.
(60) Provisional application No. 63/687,388, filed on Aug. 27, 2024.

(51) Int. Cl. H04W 74/08; H04W 88/06

(52) U.S. Cl. CPC H04W 74/08; H04W 88/06

(57) ABSTRACT

An access point (AP) receives from a station (STA) a first frame indicating: adaptive operation or a period of unavailability of the STA due to an in-device coexistence (IDC) event at the STA; a first channel, where the first channel is disabled/unavailable while the STA is in adaptive operation or during the period of unavailability; and a second channel to be used by the AP for transmission of a physical layer protocol data unit (PPDU) to the STA while the STA is in adaptive operation or during the period of unavailability. The AP transmits to the STA the PPDU via the second channel while the STA is in adaptive operation or during the period of unavailability.

### CROSS-REFERENCE TO RELATED APPLICATIONS

This application is a continuation of International Application No. PCT/US2025/043440, filed Aug. 26, 2025, which claims the benefit of U.S. Provisional Application No. 63/687,388, filed Aug. 27, 2024, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example of a Medium Access Control (MAC) frame format.

FIG. 4 illustrates an example of a Quality of Service (QoS) null frame indicating buffer status information.

FIG. 5 illustrates an example format of a physical layer (PHY) protocol data unit (PPDU).

FIG. 6 illustrates an example wireless device.

FIG. 7 illustrates a procedure in which a transmission opportunity (TXOP) may be adjusted based on a period of unavailability of a STA.

FIG. 8 illustrates another procedure in which a TXOP may be adjusted based on a period of unavailability of a STA.

FIG. 9 illustrates an example problem that may arise in the procedures illustrated in FIG. 8.

FIG. 10 illustrates an example of a procedure according to an embodiment.

FIG. 11 illustrates an example of another procedure according to an embodiment.

FIG. 12 illustrates an-example of another procedure according to an embodiment.

FIG. 13 illustrates an example of another procedure according to an embodiment.

FIG. 14 illustrates an example of another procedure according to an embodiment.

FIG. 15 illustrates an example of another procedure according to an embodiment.

FIG. 16 illustrates an example of another procedure according to an embodiment.

FIG. 17 illustrates an example process according to an embodiment.

FIG. 18 illustrates another example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages are presented for example purposes only. The disclosed architecture is sufficiently flexible and configurable, such that it may be utilized in ways other than those shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

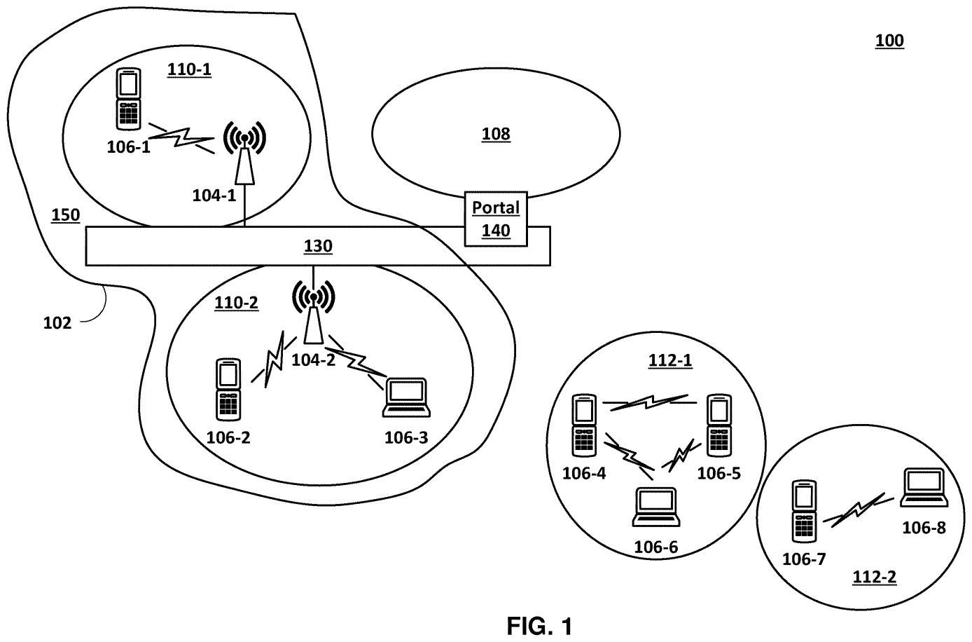

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PLCP service data unit (PSDU). For example, the PSDU may include a PHY Convergence Protocol (PLCP) preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHZ, 5 GHZ, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHZ, 80 MHZ, 160 MHZ, or 520 MHz by bonding together multiple 20 MHz channels.

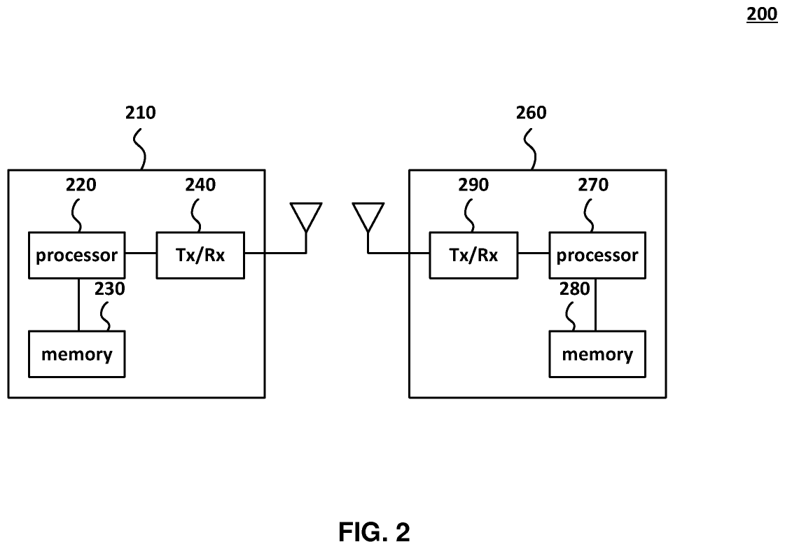

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

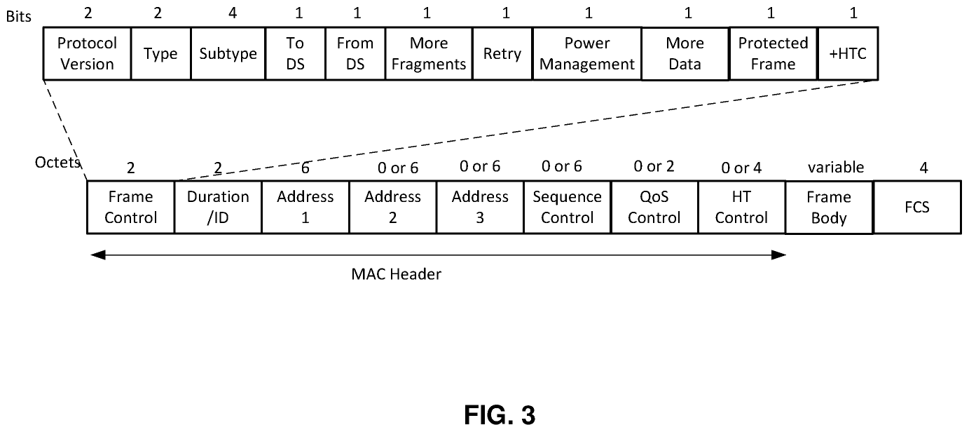

FIG. 3 illustrates an example format of a MAC frame. In operation, a STA may construct a subset of MAC frames for transmission and may decode a subset of received MAC frames upon validation. The particular subsets of frames that a STA may construct and/or decode may be determined by the functions supported by the STA. A STA may validate a received MAC frame using the frame check sequence (FCS) contained in the frame and may interpret certain fields from the MAC headers of all frames.

As shown in FIG. 3, a MAC frame includes a MAC header, a variable length frame body, and a frame check sequence (FCS).

The MAC header includes a frame control field, an optional duration/ID field, address fields, an optional sequence control field, an optional QoS control field, and an optional HT control field.

The frame control field includes the following subfields: protocol version, type, subtype, “To DS”, “From DS”, “More Fragments”, retry, power management, “More Data, protected frame, and +HTC.

The protocol version subfield is invariant in size and placement across all revisions of the IEEE 802.11 standard. The value of the protocol version subfield is 0 for MAC frames.

The type and subtype subfields together identify the function of the MAC frame. There are three frame types: control, data, and management. Each of the frame types has several defined subtypes. Bits within the subtype subfield are used to indicate a specific modification of the basic data frame (subtype 0). For example, in data frames, the most significant bit (MSB) of the subtype subfield, bit 7 (B7) of the frame control field, is defined as the QoS subfield. When the QoS subfield is set to 1, it indicates a QoS data frame, which is a data frame that contains a QoS control field in its MAC header. The second MSB of the subtype field, bit 6 (B6) of the frame control field, when set to 1 in data subtypes, indicates a data frame that contain no frame body field.

The “To DS” subfield indicates whether a data frame is destined to the distribution system (DS). The “From DS” subfield indicates whether a data frame originates from the DS.

The “More Fragments” subfield is set to 1 in all data or management frames that have another fragment to follow the MAC service data unit (MSDU) or MAC management protocol data unit (MMPDU) carried by the MAC frame. The “More Fragments” subfield is set to 0 in all other frames in which the “More Fragments” subfield is present.

The retry subfield is set to 1 in any data or management frame that is a retransmission of an earlier frame. It is set to 0 in all other frames in which the retry subfield is present. A receiving STA uses this indication to aid it in the process of eliminating duplicate frames. These rules do not apply for frames sent by a STA under a block agreement.

The power management subfield is used to indicate the power management mode of a STA.

The “More Data” subfield indicates to a STA in power save (PS) mode that bufferable units (BUs) are buffered for that STA at the AP. The “More Data” subfield is valid in individually addressed data or management frames transmitted by an AP to a STA in PS mode. The “More Data” subfield is set to 1 to indicate that at least one additional buffered BU is present for the STA.

The protected frame subfield is set to 1 if the frame body field contains information that has been processed by a cryptographic encapsulation algorithm.

The +HTC subfield indicates that the MAC frame contains an HT control field.

The duration/ID field of the MAC header indicates various contents depending on the frame type and subtype and the QoS capabilities of the sending STA. For example, in control frames of the power save poll (PS-Poll) subtype, the duration/ID field carries an association identifier (AID) of the STA that transmitted the frame in the 14 least significant bits (LSB), with the 2 most significant bits (MSB) set to 1. In other frames sent by STAs, the duration/ID field contains a duration value (in microseconds) which is used by a recipient to update a network allocation vector (NAV). The NAV is a counter that indicates to a STA an amount of time during which the STA must defer from accessing the shared medium.

Up to four address fields may be present in the MAC frame format. The address fields are used to indicate the basic service set identifier (BSSID), source address (SA), destination address (DA), transmitting address (TA), and receiving address (RA). Certain frames may not contain some of the address fields. Certain address field usage may be specified by the relative position of the address field (1-4) within the MAC header, independent of the type of address present in that field. Specifically, the address 1 field always identifies the intended receiver(s) of the frame, and the address 2 field, where present, always identifies the transmitter of the frame.

The sequence control field includes two subfields, a sequence number subfield and a fragment number subfield. The sequence number subfield in data frames indicates the sequence number of the MSDU (if not in an Aggregated MSDU (A-MSDU) or A-MSDU. The sequence number subfield in management frames indicates the sequence number of the frame. The fragment number subfield indicates the number of each fragment of an MSDU or MMPDU. The fragment number is set to 0 in the first or only fragment of an MSDU or MMPDU and is incremented by one for each successive fragment of that MSDU or MMPDU. The fragment number is set to 0 in a MAC protocol data unit (MPDU) containing an A-MSDU, or in an MPDU containing an MSDU or MMPDU that is not fragmented. The fragment number remains constant in all retransmissions of the fragment.

The QoS control field identifies the traffic category (TC) or traffic stream (TS) to which the MAC frame belongs. The QoS control field may also indicate various other QoS related, A-MSDU related, and mesh-related information about the frame. This information can vary by frame type, frame subtype, and type of transmitting STA. The QoS control field is present in all data frames in which the QoS subfield of the subtype subfield is equal to 1.

The HT control field is present in QoS data, QoS null, and management frames as determined by the +HTC subfield of the frame control field.

The frame body field is a variable length field that contains information specific to individual frame types and subtypes. The frame body may include one or more MSDUs or MMPDUs. The minimum length of the frame body is 0 octets.

The FCS field contains a 32-bit Cyclic Redundancy Check (CRC) code. The FCS field value is calculated over all of the fields of the MAC header and the frame body field.

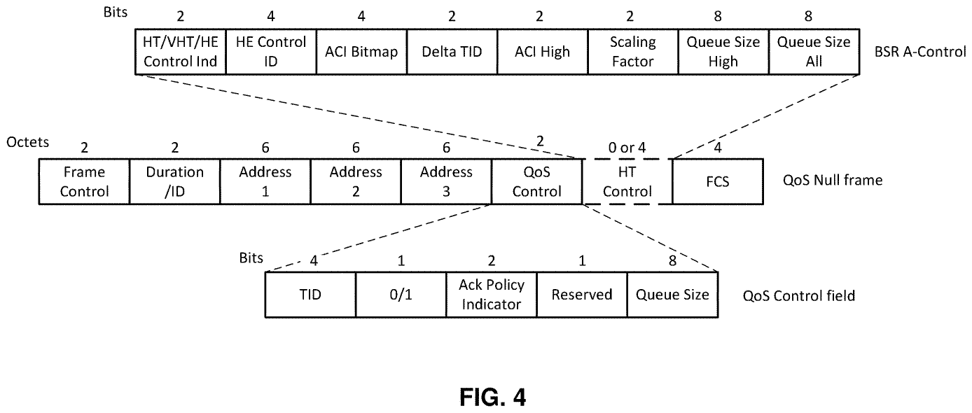

FIG. 4 illustrates an example of a QoS null frame indicating buffer status information. A QoS null frame refers to a QoS data frame with an empty frame body. A QoS null frame includes a QoS control field and an optional HT control field which may contain a buffer status report (BSR) control subfield. A QoS null frame indicating buffer status information may be transmitted by a STA to an AP.

The QoS control field may include a traffic identifier (TID) subfield, an ack policy indicator subfield, and a queue size subfield (or a transmission opportunity (TXOP) duration requested subfield).

The TID subfield identifies the TC or TS of traffic for which a TXOP is being requested, through the setting of the TXOP duration requested or queue size subfield. The encoding of the TID subfield depends on the access policy (e.g., Allowed value 0 to 7 for enhanced distributed channel access (EDCA) access policy to identify user priority for either TC or TS).

The ack policy indicator subfield, together with other information, identifies the acknowledgment policy followed upon delivery of the MPDU (e.g., normal ack, implicit block ack request, no ack, block ack, etc.)

The queue size subfield is an 8-bit field that indicates the amount of buffered traffic for a given TC or TS at the STA for transmission to the AP identified by the receiver address of the frame containing the subfield. The queue size subfield is present in QoS null frames sent by a STA when bit 4 of the QoS control field is set to 1. The AP may use information contained in the queue size subfield to determine t TXOP duration assigned to the STA or to determine the uplink (UL) resources assigned to the STA.

In a frame sent by or to a non-High Efficiency (non-HE) STA, the following rules may apply to the queue size value:
The queue size value is the approximate total size, rounded up to the nearest multiple of 256 octets and expressed in units of 256 octets, of all MSDUs and A-MSDUs buffered at the STA (excluding the MSDU or A-MSDU contained in the present QoS Data frame) in the delivery queue used for MSDUs and A-MSDUs with TID values equal to the value indicated in the TID subfield of the QoS Control field.
A queue size value of 0 is used solely to indicate the absence of any buffered traffic in the queue used for the specified TID.
A queue size value of 254 is used for all sizes greater than 64 768 octets.
A queue size value of 255 is used to indicate an unspecified or unknown size.

In a frame sent by an HE STA to an HE AP, the following rules may apply to the queue size value.

The queue size value, QS, is the approximate total size in octets, of all MSDUs and A-MSDUs buffered at the STA (including the MSDUs or A-MSDUs contained in the same PSDU as the frame containing the queue size subfield) in the delivery queue used for MSDUs and A-MSDUs with TID values equal to the value indicated in the TID subfield of the QoS control field.

The queue size subfield includes a scaling factor subfield in bits B14-B15 of the QoS control field and an unscaled value, UV, in bits B8-B13 of the QoS control field. The scaling factor subfield provides the scaling factor, SF.

A STA obtains the queue size, QS, from a received QoS control field, which contains a scaling factor, SF, and an unscaled value, UV, as follows:
QS=
16×UV, if SF is equal to 0;
1024+256× UV, if SF is equal to 1;
17 408+2048×UV, if SF is equal to 2;
148 480+32 768×UV, if SF is equal to 3 and UV is less than 62;
>2 147 328, if SF equal to is 3 and UV is equal to 62;
Unspecified or Unknown, if SF is equal to 3 and UV is equal to 63.

The TXOP duration requested subfield, which may be included instead of the queue size subfield, indicates the duration, in units of 32 microseconds (us), that the sending STA determines it needs for its next TXOP for the specified TID. The TXOP duration requested subfield is set to 0 to indicate that no TXOP is requested for the specified TID in the current service period (SP). The TXOP duration requested subfield is set to a nonzero value to indicate a requested TXOP duration in the range of 32 μs to 8160 μs in increments of 32 μs.

The HT control field may include a BSR control subfield which may contain buffer status information used for UL MU operation. The BSR control subfield may be formed from an access category index (ACI) bitmap subfield, a delta TID subfield, an ACI high subfield, a scaling factor subfield, a queue size high subfield, and a queue size all subfield of the HT control field.

The ACI bitmap subfield indicates the access categories (ACs) for which buffer status is reported (e.g., B0: best effort (AC_BE), B1: background (AC_BK), B2: video (AC_VI), B3: voice (AC_VO), etc.). Each bit of the ACI bitmap subfield is set to 1 to indicate that the buffer status of the corresponding AC is included in the queue size all subfield, and set to 0 otherwise, except that if the ACI bitmap subfield is 0 and the delta TID subfield is 3, then the buffer status of all 8 TIDs is included.

The delta TID subfield, together with the values of the ACI bitmap subfield, indicate the number of TIDs for which the STA is reporting the buffer status.

The ACI high subfield indicates the ACI of the AC for which the BSR is indicated in the queue size high subfield. The ACI to AC mapping is defined as ACI value 0 mapping to AC_BE, ACI value 1 mapping to AC_BK, ACI value 2 mapping to AC_VI, and ACI value 3 mapping to AC_VO.

The scaling factor subfield indicates the unit SF, in octets, of the queue size high and queue size all subfields.

The queue size high subfield indicates the amount of buffered traffic, in units of SF octets, for the AC identified by the ACI high subfield, that is intended for the STA identified by the receiver address of the frame containing the BSR control subfield.

The queue size all subfield indicates the amount of buffered traffic, in units of SF octets, for all ACs identified by the ACI Bitmap subfield, that is intended for the STA identified by the receiver address of the frame containing the BSR control subfield.

The queue size values in the queue size high and queue size all subfields are the total sizes, rounded up to the nearest multiple of SF octets, of all MSDUs and A-MSDUs buffered at the STA (including the MSDUs or A-MSDUs contained in the same PSDU as the frame containing the BSR control subfield) in delivery queues used for MSDUs and A-MSDUs associated with AC(s) that are specified in the ACI high and ACI bitmap subfields, respectively.

A queue size value of 254 in the queue size high and queue size all subfields indicates that the amount of buffered traffic is greater than 254×SF octets. A queue size value of 255 in the queue size high and queue size all subfields indicates that the amount of buffered traffic is an unspecified or unknown size. The queue size value of QoS data frames containing fragments may remain constant even if the amount of queued traffic changes as successive fragments are transmitted.

MAC service provides peer entities with the ability to exchange MSDUs. To support this service, a local MAC uses the underlying PHY-level service to transport the MSDUs to a peer MAC entity. Such asynchronous MSDU transport is performed on a connectionless basis.

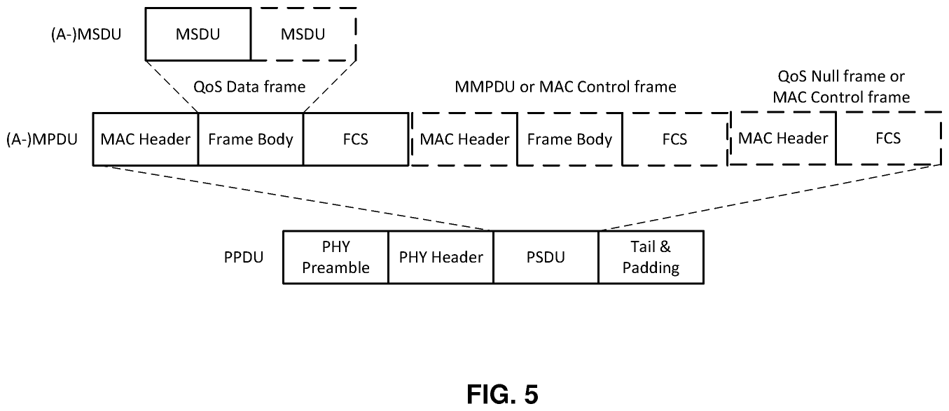

FIG. 5 illustrates an example format of a PPDU. As shown, the PPDU may include a PHY preamble, a PHY header, a PSDU, and tail and padding bits.

The PSDU may include one or more MPDUs, such as a QoS data frame, an MMPDU, a MAC control frame, or a QoS null frame. In the case of an MPDU carrying a QoS data frame, the frame body of the MPDU may include a MSDU or an A-MSDU.

By default, MSDU transport is on a best-effort basis. That is, there is no guarantee that a transmitted MSDU will be delivered successfully. However, the QoS facility uses a traffic identifier (TID) to specify differentiated services on a per-MSDU basis.

A STA may differentiate MSDU delivery according to designated traffic category (TC) or traffic stream (TS) of individual MSDUs. The MAC sublayer entities determine a user priority (UP) for an MSDU based on a TID value provided with the MSDU. The QoS facility supports eight UP values. The UP values range from 0 to 7 and form an ordered sequence of priorities, with 1 being the lowest value, 7 the highest value, and 0 falling between 2 and 3.

An MSDU with a particular UP is said to belong to a traffic category with that UP. The UP may be provided with each MSDU at the medium access control service access point (MAC SAP) directly in a UP parameter. An A-MPDU may include MPDUs with different TID values.

A STA may deliver buffer status reports (BSRs) to assist an AP in allocating UL MU resources. The STA may either implicitly deliver BSRs in the QoS control field or BSR control subfield of any frame transmitted to the AP (unsolicited BSR) or explicitly deliver BSRs in a frame sent to the AP in response to a BSRP Trigger frame (solicited BSR).

The buffer status reported in the QoS control field includes a queue size value for a given TID. The buffer status reported in the BSR control field includes an ACI bitmap, delta TID, a high priority AC, and two queue sizes.

A STA may report buffer status to the AP, in the QoS control field, of transmitted QoS null frames and QoS data frames and, in the BSR control subfield (if present), of transmitted QoS null frames, QoS data frames, and management frames as defined below.

The STA may report the queue size for a given TID in the queue size subfield of the QoS control field of transmitted QoS data frames or QoS null frames; the STA may set the queue size subfield to 255 to indicate an unknown/unspecified queue size for that TID. The STA may aggregate multiple QoS data frames or QoS null frames in an A-MPDU to report the queue size for different TIDs.

The STA may report buffer status in the BSR control subfield of transmitted frames if the AP has indicated its support for receiving the BSR control subfield.

A High-Efficiency (HE) STA may report the queue size for a preferred AC, indicated by the ACI high subfield, in the queue size high subfield of the BSR control subfield. The STA may set the queue size high subfield to 255 to indicate an unknown/unspecified queue size for that AC.

A HE STA may report the queue size for ACs indicated by the ACI bitmap subfield in the queue size all subfield of the BSR control subfield. The STA may set the queue size all subfield to 255 to indicate an unknown/unspecified BSR for those ACs.

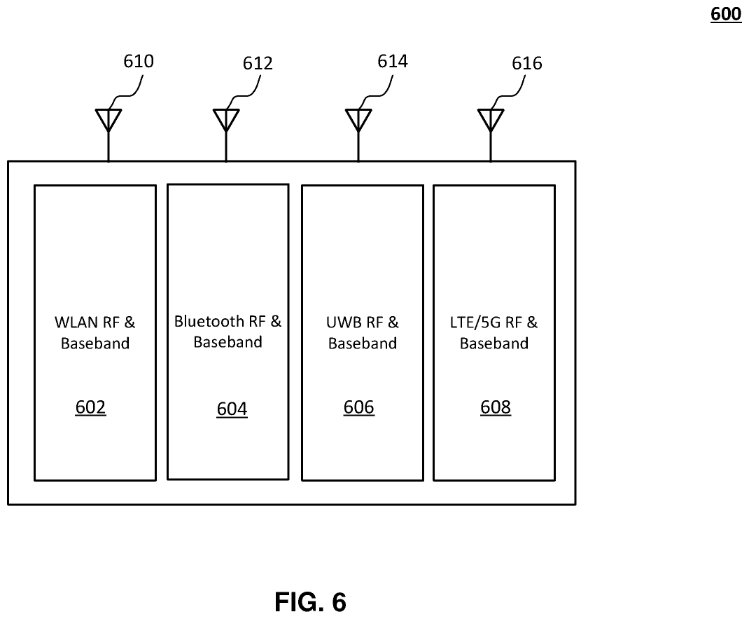

FIG. 6 illustrates an example wireless device 600. Wireless device 600 may support a plurality of radio technologies, including wireless local area network (WLAN) (e.g., IEEE 802.11 Wi-Fi®), Bluetooth®, ultra-wideband (UWB), and long-term evolution (LTE)/5G, for example. As such, as shown in FIG. 6, wireless device 600 may comprise a plurality of radio modules, including a WLAN radio module 602, a Bluetooth® radio module 604, a UWB radio module 606, and an LTE/5G radio module 608, for example. Each radio module of radio modules 602, 604, 606, and 608 may comprise a baseband processor and radio frequency (RF) circuitry for the respective radio technology supported by the radio module. Radio modules 602, 604, 606, and 608 may be coupled respectively to antennas 610, 612, 614, and 616.

Wireless device 600 may comprise or operate as a non-AP STA or an AP STA. Wireless device 600 may be, for example, an embodiment of STA 210 or AP 260 illustrated in FIG. 2. In operation, radio modules 602, 604, 606, and 608 may interfere with each other. For example, a transmission by WLAN radio module 602 may interfere with a reception by Bluetooth® radio module 604, UWB radio module 606, and/or LTE/5G radio module 608. Alternatively, a transmission by Bluetooth® radio module 604, UWB radio module 606, or LTE/5G radio module 608 may interfere with a reception by WLAN module 602. Such interference events may be referred to as in-device coexistence (IDC) interference events.

To reduce IDC interference events, wireless device 600 may be configured to avoid transmitting using a first radio module when the transmission using the first radio module is expected to or is likely to interfere with the reception using one or more second radio modules of wireless device 600. Alternatively, or additionally, wireless device 600 may be configured to avoid receiving using the first radio module when transmission using the one or more second radio modules is expected to or is likely to interfere with the reception using the first radio module. For example, wireless device 600 may be configured to avoid transmitting using a WLAN module 602 when the transmission using WLAN module 602 is expected to or is likely to interfere with the reception using Bluetooth® radio module 604, UWB radio module 606, and/or LTE/5G radio module 608 of wireless device 600. Alternatively, or additionally, wireless device 600 may be configured to avoid receiving using WLAN module 602 when transmission using Bluetooth® radio module 604, UWB radio module 606, and/or LTE/5G radio module 608 is expected to or is likely to interfere with the reception using WLAN module 602.

When wireless device 600 operates as a non-AP STA or an AP STA, the time periods during which wireless device 600 may avoid transmitting and/or receiving using WLAN module 602 (to avoid the occurrence of IDC interference events) may correspond to periods of unavailability for the non-AP STA or the AP STA. That is, the non-AP STA or the AP STA embodied by wireless device 600 may be unavailable to communicate with other WLAN devices (e.g., a peer non-AP STA(s) or an AP STA(s) during those time periods.

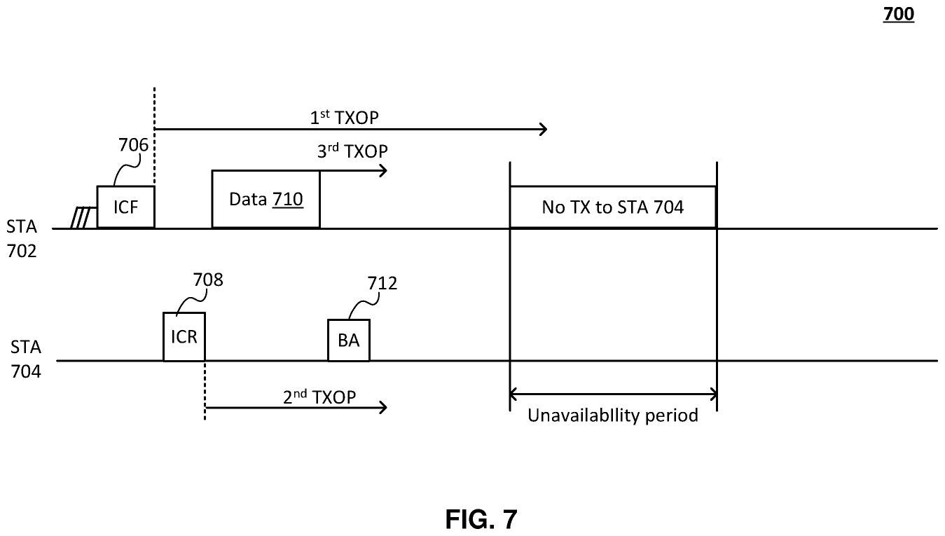

FIG. 7 illustrates an example 700 of a procedure in which a transmission opportunity (TXOP) may be adjusted based on a period of unavailability of a STA. As shown in FIG. 7, example 700 includes a STA 702 and a STA 704. STAs 702 and 704 may each be a non-AP STA or an AP STA. In an example, STA 702 may be an AP STA and STA 704 may be a non-AP STA. In an example, STA 704 may be associated with STA 702.

Example 700 may begin with STA 702 transmitting an initial control frame (ICF) 706 to STA 704. ICF 706 may be a control frame, such as a request-to-send (RTS) frame, for example. ICF 706 may indicate a first transmission opportunity (TXOP). In an implementation, a duration of the first TXOP may be indicated in a duration field of ICF 706. ICF 706 may reserve the wireless medium for the duration of the first TXOP.

On receiving ICF 706, STA 704 may determine that STA 702 intends to communicate with STA 704 during the first TXOP. STA 704 may further determine that the first TXOP overlaps with a period of unavailability of STA 704. The period of unavailability may be due to an IDC event within STA 704. STA 704 may be unavailable for communication with other WLAN devices, including STA 702, during the period of unavailability to avoid the occurrence of an IDC interference event due to the IDC event.

In response to ICF 706, STA 704 may transmit to STA 702 an initial control response (ICR) 708 that indicates a second TXOP that does not overlap with the period of unavailability of STA 704. ICR 708 may be a control frame, such as a clear-to-send (CTS) frame, for example. In an implementation, ICR 708 may include information regarding the period of unavailability of STA 704. In an implementation, the second TXOP may be set to a shorter value than a value indicated in the first TXOP. In this case, as shown in FIG. 7, the end time of the second TXOP may end earlier than the end time of the first TXOP. casein another implementation (not shown in FIG. 7), the end time of the second TXOP may be equal to the end time of the first TXOP. In an implementation, a duration of the second TXOP may be indicated in a duration field of ICR 708. In another implementation, a duration of the second TXOP may be indicated in another field than a duration field of ICR 708. The other field may be a new field or an existing field of ICR 708. In another implementation, a duration of the second TXOP may be indicated in a duration field of ICR 708 and the period of unavailability of STA 704 may be indicated in another field of ICR 708. In this case, the end time of the second TXOP may be equal to the end time of the first TXOP. The other field may be a new field or an existing field of ICR 708.

On receiving ICR 708, STA 702 may initiate transmission of a data frame 710 to STA 704. Data frame 710 may indicate a third TXOP based on the second TXOP indicated in ICR 708. In an implementation, an end time of the third TXOP may be equal to an end time of the second TXOP as shown in FIG. 7. As such, the third TXOP avoids the period of unavailability of STA 704, and communication between STA 702 and STA 704 can end before a start of the period of unavailability of STA 704. In another implementation, an end time of the second TXOP may be equal to an end time of the first TXOP. In this case, an end time of the third TXOP may be different from (e.g., shorter than) an end time of the second TXOP (not shown in FIG. 7). As such, the third TXOP avoids the period of unavailability of STA 704, and communication between STA 702 and STA 704 can end before a start of the period of unavailability of STA 704.

STA 704 may respond to data frame 710 by transmitting to STA 702 a BlockAck (BA) frame 712 marking the end of the third TXOP. Subsequently, the period of unavailability begins at STA 704, and STA 704 becomes unavailable for communication. In an implementation, based on receiving the information regarding the period of unavailability of STA 704 in ICR 708, STA 702 may refrain from any transmission to STA 704 during the period of unavailability of STA 704. In an implementation, after receiving BA frame 712, STA 702 may transmit a CF-End frame (not shown in FIG. 7).

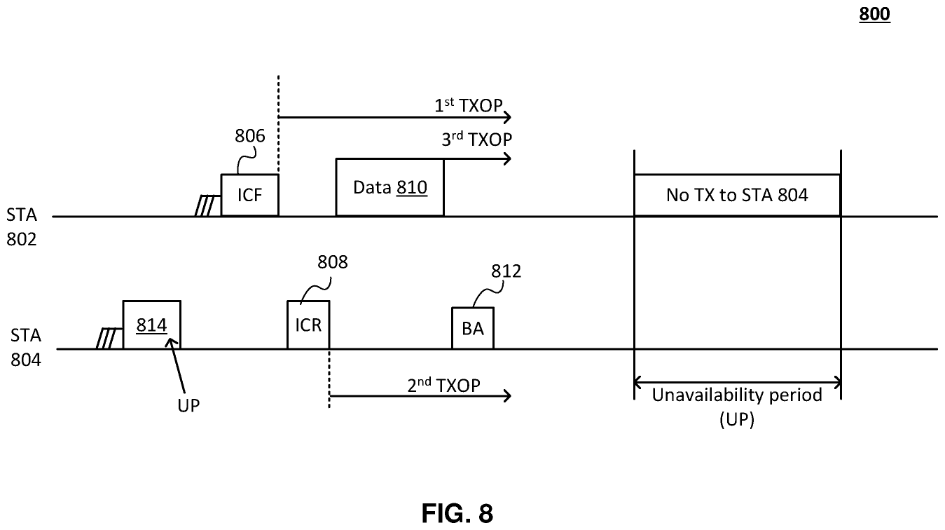

FIG. 8 illustrates an example 800 of another procedure in which a TXOP may be adjusted based on a period of unavailability of a STA. As shown in FIG. 8, example 800 includes a STA 802 and a STA 804. STAs 802 and 804 may each be a non-AP STA or an AP STA. In an example, STA 802 may be an AP STA and STA 804 may be a non-AP STA. In an example, STA 804 may be associated with STA 802.

Example 800 may begin with STA 804 transmitting to STA 802 a frame 814 indicating a period of unavailability of STA 804. The period of unavailability may be due to an IDC event within STA 804. STA 804 may be unavailable for communication with other WLAN devices, including STA 802, during the period of unavailability to avoid the occurrence of an IDC interference event due to the IDC event. Frame 814 may be a data frame, a control frame, a management frame, or an action frame, for example.

Subsequently, STA 802 may transmit an ICF 806 to STA 804. ICF 806 may be a control frame, such as an RTS frame, for example. ICF 806 may be a management frame, a data frame, or a QoS null frame. ICF 806 may indicate a first TXOP. Based on the information regarding the period of unavailability of STA 804 received in frame 814, STA 802 may be configured to set the first TXOP so as not overlap with the period of unavailability of STA 804. For example, as shown in FIG. 8, STA 802 may be configured to set the first TXOP to end before a start of the period of unavailability of STA 804. In an implementation, a duration of the first TXOP may be indicated in a duration field of ICF 806. ICF 806 may reserve the wireless medium for the duration of the first TXOP.

On receiving ICF 806, STA 804 may determine that STA 802 intends to communicate with STA 804 during the first TXOP. STA 804 may further determine that the first TXOP does not overlap with the period of unavailability of STA 804. In response to ICF 806, STA 804 may transmit to STA 802 an ICR 808 that indicates a second TXOP based on the first TXOP. In an implementation, an end time of the second TXOP is equal to an end time of the first TXOP. ICR 808 may be a control frame, such as a CTS frame, for example.

On receiving ICR 808, STA 802 may initiate transmission of a data frame 810 to STA 804. Data frame 810 may indicate a third TXOP based on the second TXOP indicated in ICR 808. In an implementation, an end time of the third TXOP is equal to an end time of the second TXOP. The third TXOP avoids the period of unavailability of STA 804, and communication between STA 802 and STA 804 can end before a start of the period of unavailability of STA 804.

STA 804 may respond to data frame 810 by transmitting to STA 802 a BA frame 812 marking the end of the third TXOP. Subsequently, the period of unavailability begins at STA 804, and STA 804 becomes unavailable for communication. Based on receiving the information regarding the period of unavailability of STA 804 in frame 814, STA 802 may refrain from any transmission to STA 804 during the period of unavailability of STA 804.

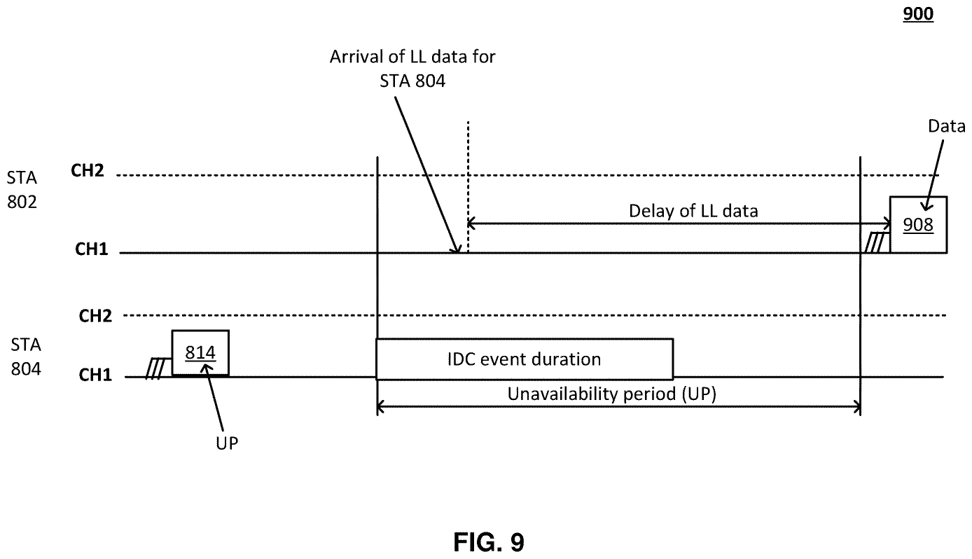

FIG. 9 shows an example 900 that illustrates a problem that may arise in the procedure illustrated in FIG. 8. As shown in FIG. 9, example 900 may also begin with the transmission by STA 804 to STA 802 of frame 814. As described above, frame 814 indicates a period of unavailability of STA 804.

Subsequently, after the period of unavailability begins at STA 804, data for STA 804 arrives at STA 802. In an example, the data may be low latency (LL) data that requires urgent transmission to STA 804. However, as STA 802 is configured to refrain from any transmission to STA 804 during the period of unavailability of STA 804 (in accordance with the procedure of FIG. 8), STA 802 may only buffer the arriving data for STA 802 and may only transmit the data after the end of the period of unavailability of STA 804, e.g., in a data frame 902.

In some cases, however, the period of unavailability of STA 804 may relate to a particular channel on which STA 804 may operate. For example, in example 900, the period of unavailability indicated in frame 814 may relate to a first channel (e.g., CH1). For example, an IDC event on the first channel may cause the period of unavailability indicated in frame 814. Further, STAs 802 and 804 may be capable of operating on a second channel (e.g., CH2) during the period of unavailability of STA 804 and may transmit/receive frames via the second channel during the period of unavailability. However, as frame 814 only indicates that STA 804 is unavailable during the period of unavailability, STA 802 may not initiate communication with STA 804 during the period of unavailability despite the possibility of communication with STA 804 via the second channel (e.g., CH2). This may result in the transmission of the data to STA 804 being unnecessarily delayed, and, in the case of LL data, may cause the data to be discarded and lost at STA 802.

Embodiments of the present disclosure, as further described below, address the above-described problems of existing technologies. In an aspect, a first STA transmits to a second STA a first frame indicating: a period of unavailability (or limited/reduced/adaptive availability/operation) of the first STA; a first channel to which the period of unavailability (or limited/reduced/adaptive availability/operation) applies; and a second channel to be used or that may be used by the second STA for transmission of a physical protocol data unit (PPDU), during the period of unavailability (or while the first STA is in limited/reduced/adaptive availability/operation), to the first STA. In an embodiment, the first frame may further indicate a condition (or modified parameter) for transmission of the PPDU, during the period of unavailability (or while the first STA is in limited/reduced/adaptive availability/operation) and via the second channel, to the first STA. In an embodiment, when the first frame indicates a second channel or a condition (or modified parameter) for transmission of a PPDU during a period of unavailability of the first STA, the period of unavailability may be equivalent to, and may be referred to as, a period of limited/reduced/adaptive availability/operation of the first STA. The first frame may indicate limited/reduced/adaptive availability/operation of the first STA or a period of limited/reduced/adaptive availability/operation of the first STA.

In an embodiment, the condition comprises the PPDU comprising a data frame with a traffic identifier (TID) equal to a first TID or with an access category (AC) equal to a first AC. In another embodiment, the condition comprises the PPDU having a size/duration lower than or equal to a threshold. In a further embodiment, the condition comprises the PPDU comprising a frame of a first frame type.

In an embodiment, the condition is based on (or may vary based on) the position of the second channel relative to the first channel. In another embodiment, the condition is based on a type of the radio access technology (RAT) to which the IDC event is due. In a further embodiment, the condition is based on a type of the communication event during the IDC event.

In an embodiment, the first STA receives from the second STA via the second channel, during the period of unavailability of the first STA (or while the first STA is in limited/reduced/adaptive availability/operation), a first PPDU based on the condition. As such, transmissions to the first STA during the period of unavailability of the first STA (or while the first STA is in limited/reduced/adaptive availability/operation) may occur via the second channel when such transmissions are tolerated by the first STA. This may decrease the latency for transmissions that may not be allowed via the first channel to the first STA during the period of unavailability of the first STA (or while the first STA is in limited/reduced/adaptive availability/operation). Additionally, with the condition being variable, the transmissions that may be allowed via the second channel to the first STA may be varied (e.g., in terms of traffic type, size/duration, frame type, etc.) based on the potential interference impact of the transmissions. This allows for a greater selectivity regarding the type of transmissions that may be allowed to be transmitted to the first STA via the second channel during the period of unavailability of the first STA (or while the first STA is in limited/reduced/adaptive availability/operation) and enables a better balancing between faster transmissions to the first STA and lower interference to ongoing IDC events at the first STA.

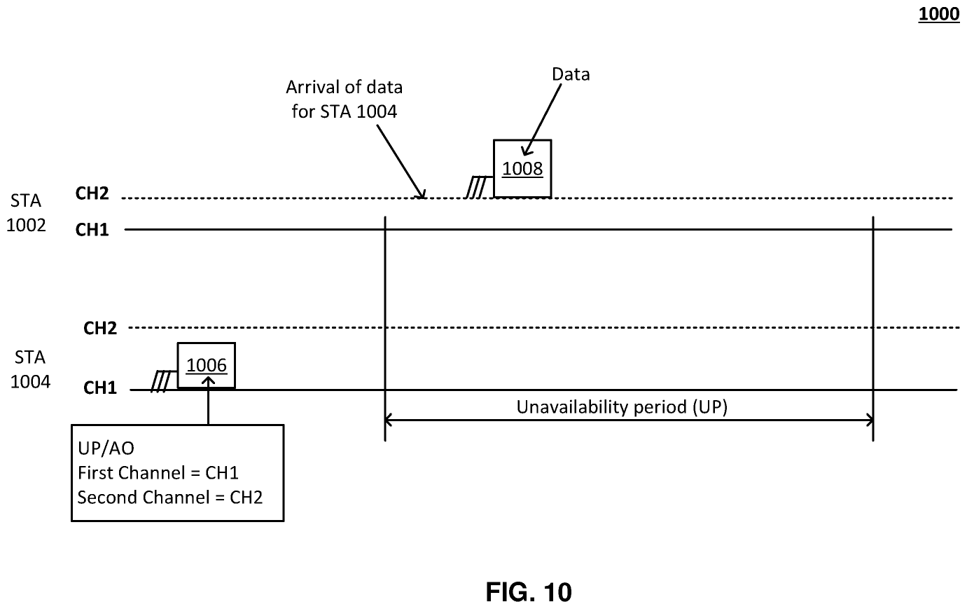

FIG. 10 illustrates an example 1000 of a procedure according to an embodiment. Example 1000 is provided for the purpose of illustration only and is not limiting of embodiments. As shown in FIG. 10, example 1000 includes a STA 1002 and a STA 1004. STA 1002 may be an AP STA or a non-AP STA. Similarly, STA 1004 may be an AP STA or a non-AP STA. In an embodiment, STA 1002 may be an AP STA, and STA 1004 may be a non-AP STA. STA 1004 may be associated with STA 1002. In another embodiment, STA 1002 may be a non-AP STA, and STA 1004 may be an AP STA. STA 1002 may be associated with STA 1004. STA 1002 and STA 1004 may operate over multiple channels, including a channel CH1 and a channel CH2. CH1 may comprise a primary channel of STA 1002. The primary channel of STA 1002 may comprise a 20 MHz primary channel, a 40 MHz primary channel, an 80 MHz primary channel, or a 160 MHz primary channel. Channel (CH2) may comprise a secondary channel of STA 1102. The secondary channel of STA 1002 may comprise a 20 MHz secondary channel, a 40 MHz secondary channel, an 80 MHz secondary channel, or a 160 MHz secondary channel. CH1 and CH1 may be adjacent (not separated by another channel), non-adjacent (separated by another channel), or overlapping (sharing common frequencies) channels.

As shown in FIG. 10, example 1000 may begin with STA 1004 transmitting a frame 1006 to STA 1002. In embodiments, frame 1006 may comprise an initial control frame (ICF) an initial control response frame (ICR), a request frame, a response frame, a control frame, a management frame, an action frame, a QoS null frame, or a QoS data frame, for example. In an embodiment, frame 1006 comprises an ICR transmitted by STA 1004 in response to an ICF frame from STA 1002. In an embodiment, the ICR transmitted by STA 1004 comprises a multi-STA BlockAck frame, and the ICF transmitted by STA 1002 comprises a BSRP Trigger frame. In an embodiment, STA 1002 transmits the ICF to initiate frame exchanges (that are neither group addressed Data nor group address Management frames) with STA 1004 when STA 1004 operates in a mode in which STA 1004 may inform another STA of its limited/reduced/adaptive availability/operation (e.g., Dynamic Unavailability Operation (DUO) mode, Periodic Unavailability Operation (PUO) mode, or Limited Operation Mode (LOM). LOM may also be referred to as Adaptive Operation Mode (AOM). In LOM/AOM, a STA may reduce/adapt (or may request from an associated AP to reduce/adapt) parameters/conditions used for communication (transmission/reception) with the STA. In another embodiment, where STA 1004 is a TXOP holder, frame 1006 comprises a BSRP Trigger frame.

In an embodiment, frame 1006 may indicate a period of unavailability (or limited/reduced/adaptive availability/operation) of STA 1004. The period of unavailability (or limited/reduced/adaptive availability/operation) may be periodic or aperiodic. The period of unavailability (or limited/reduced/adaptive availability/operation) may be due to an IDC event within STA 1004. In an embodiment, frame 1006 may also indicate a first channel to which the period of unavailability (or limited/reduced/adaptive availability/operation) applies. In an embodiment, STA 1004 may be unavailable for communication via the first channel with other WLAN devices, including STA 1002, during at least a portion of the period of unavailability (or while in limited/reduced/adaptive availability/operation) to avoid the occurrence of an IDC interference event due to the IDC event. In example 1000, the first channel indicated in frame 1006 comprises CH1. In an embodiment, frame 1006 may further indicate a second channel to be used or that may be used by STA 1002 for transmission of a PPDU, during the period of unavailability of STA 1004 (or while STA 1004 is in limited/reduced/adaptive availability/operation), to STA 1004. In example 1000, the second channel indicated in frame 1006 comprises CH2. In an embodiment, frame 1006 indicates whether one or more channels that fall within a BSS bandwidth of the BSS of STA 1004 are enabled or disabled when STA 1004 operates in limited/reduced/adaptive availability/operation mode. In an embodiment, frame 1006 includes a channel bitmap with a respective bit for each channel indicating whether the channel is enabled/disabled when STA 1004 operates in limited/reduced/adaptive availability/operation mode. Based on receiving frame 1006, STA 1002 may determine that the period of unavailability (or limited/reduced/adaptive availability/operation) of STA 1004 applies to the first channel (CH1) and that transmission to STA 1004, during the period of unavailability of STA 1004 (or while STA 1004 is in limited/reduced/adaptive availability/operation), may be performed via the second channel (CH2). In an embodiment, frame 1006 indicates a start time and a duration for the period of unavailability (or limited/reduced/adaptive availability/operation).

Subsequently, the period of unavailability (or limited/reduced/adaptive availability/operation) of STA 1004 begins and data for STA 1004 may arrive at STA 1002. For example, the data may comprise LL data. Based on the information in frame 1006, STA 1002 may determine that data for STA 1004 may be transmitted to STA 1004, without waiting for an end of the period of unavailability (or limited/reduced/adaptive availability/operation) of STA 1004, via the second channel. As such, STA 1002 may transmit to STA 1004, during the period of unavailability of STA 1004 (or while STA 1004 is in limited/reduced/adaptive availability/operation) and via the second channel, a frame 1008 comprising the buffered data for STA 1004.

As illustrated in example 1000, the embodiment of FIG. 10 allows STA 1002 to transmit arriving data for STA 1004 without waiting for an end of the indicated period of unavailability (or limited/reduced/adaptive availability/operation) of STA 1004. As such, STA 1004 can receive the data in a relatively short time after its arrival at STA 1002. This may prevent the buffered data from being discarded.

However, in some cases, the transmission of frame 1008, even though performed via the second channel, may interfere with the IDC event (e.g., occurring on the first channel) and may result in an IDC interference event at STA 1004. In the embodiments described below, solutions to reduce this potential interference and to enable a better balancing between faster transmissions and lower interference to ongoing IDC events are described.

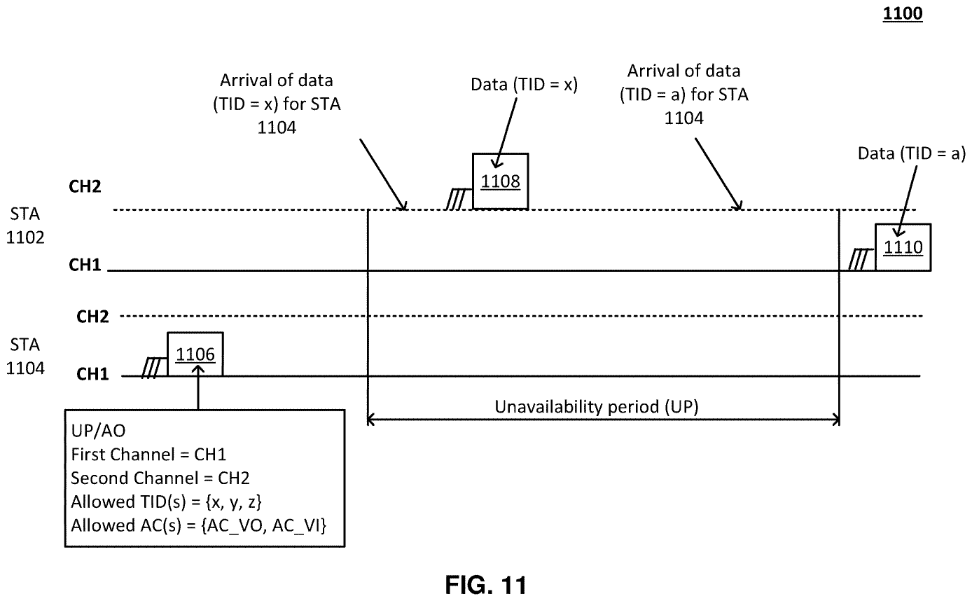

FIG. 11 illustrates an example 1100 of another procedure according to an embodiment. Example 1100 is provided for the purpose of illustration only and is not limiting of embodiments. As shown in FIG. 11, example 1100 includes a STA 1102 and a STA 1104. STA 1102 may be an AP STA or a non-AP STA. Similarly, STA 1104 may be an AP STA or a non-AP STA. In an embodiment, STA 1102 may be an AP STA, and STA 1104 may be a non-AP STA. STA 1104 may be associated with STA 1102. In another embodiment, STA 1102 may be a non-AP STA, and STA 1104 may be an AP STA. STA 1102 may be associated with STA 1104. STA 1102 and STA 1104 may operate over multiple channels, including a channel CH1 and a channel CH2. CH1 may comprise a primary channel of STA 1102. The primary channel of STA 1102 may comprise a 20 MHz primary channel, a 40 MHz primary channel, an 80 MHz primary channel, or a 160 MHz primary channel. CH2 may comprise a secondary channel of STA 1102. The secondary channel of STA 1102 may comprise a 20 MHz secondary channel, a 40 MHz secondary channel, an 80 MHz secondary channel, or a 160 MHz secondary channel. CH1 and CH2 may be adjacent, non-adjacent, or overlapping channels.

As shown in FIG. 11, example 1100 may begin with STA 1104 transmitting a frame 1106 to STA 1102. In embodiments, frame 1106 may comprise an initial control frame (ICF) an initial control response frame (ICR), a request frame, a response frame, a control frame, a management frame, an action frame, a QoS null frame, or a QoS data frame, for example. In an embodiment, frame 1106 comprises an ICR transmitted by STA 1104 in response to an ICF frame from STA 1102. In an embodiment, the ICR transmitted by STA 1104 comprises a multi-STA BlockAck frame, and the ICF transmitted by STA 1102 comprises a BSRP Trigger frame. In an embodiment, STA 1102 transmits the ICF to initiate frame exchanges (that are neither group addressed Data nor group address Management frames) with STA 1104 when STA 1104 operates in a mode in which STA 1104 may inform another STA of its limited/reduced/adaptive availability/operation (e.g., Dynamic Unavailability Operation (DUO) mode, Periodic Unavailability Operation (PUO) mode, or Limited Operation Mode (LOM). LOM may also be referred to as Adaptive Operation Mode (AOM). In LOM/AOM, a STA may reduce/adapt (or may request from an associated AP to reduce/adapt) parameters used for communication (transmission/reception) with the STA. In another embodiment, where STA 1104 is a TXOP holder, frame 1106 comprises a BSRP Trigger frame.

In an embodiment, frame 1106 may indicate a period of unavailability (or limited/reduced/adaptive availability/operation) of STA 1104. The period of unavailability (or limited/reduced/adaptive availability/operation) may be periodic or aperiodic. The period of unavailability (or limited/reduced/adaptive availability/operation) may be due to an IDC event within STA 1104. In an embodiment, frame 1106 may also indicate a first channel to which the period of unavailability (or limited/reduced/adaptive availability/operation) applies. In an embodiment, STA 1104 may be unavailable for communication via the first channel with other WLAN devices, including STA 1102, during at least a portion of the period of unavailability (or limited/reduced/adaptive availability/operation) to avoid the occurrence of an IDC interference event due to the IDC event. In example 1100, the first channel indicated in frame 1106 comprises CH1. In an embodiment, frame 1106 may further indicate a second channel to be used or that may be used by STA 1102 for transmission of a PPDU, during the period of unavailability of STA 1004 (or while STA 1104 is in limited/reduced/adaptive availability/operation), to STA 1104. In example 1100, the second channel indicated in frame 1106 comprises CH2. In an embodiment, frame 1106 indicates whether one or more channels that fall within a BSS bandwidth of the BSS of STA 1104 are enabled or disabled when STA 1104 operates in limited/reduced/adaptive availability/operation mode. In an embodiment, frame 1106 includes a channel bitmap with a respective bit for each channel indicating whether the channel is enabled/disabled when STA 1104 operates in limited/reduced/adaptive availability/operation mode. In an embodiment, frame 1106 indicates a start time and a duration for the period of unavailability (or limited/reduced/adaptive availability/operation).

In an embodiment, frame 1106 further indicates a condition for transmission of a PPDU by STA 1102 to STA 1104 during the period of unavailability of STA 1104 (or while STA 1104 is in limited/reduced/adaptive availability/operation) using the second channel (e.g., CH2 in example 1100). In other words, frame 1106 indicates that, notwithstanding the indicated period of unavailability (or limited/reduced/adaptive availability/operation) of STA 1104, a PPDU may be transmitted to STA 1104 using the second channel, during the period of unavailability of STA 1104 (or while STA 1104 is in limited/reduced/adaptive availability/operation), provided that the PPDU satisfies the condition indicated in frame 1106. In another embodiment, rather than indicating the condition for transmission to STA 1104 during the period of unavailability of STA 1104 (or while STA 1104 is in limited/reduced/adaptive availability/operation) in frame 1106, the condition may be indicated in another frame (not shown in FIG. 11) transmitted by STA 1104 to STA 1102 or may be pre-configured within STA 1102.

In an embodiment, as illustrated in FIG. 11, the condition comprises the PPDU comprising a data frame with a TID equal to one of one or more first TIDs (e.g., x, y, z) and/or with an access category (AC) equal to one of one or more first ACs (e.g., AC_VO, AC_VI). The one or more first TIDs and/or the one or more first ACs may correspond to traffic that STA 1104 wishes to receive during the period of unavailability of STA 1104 (or while STA 1104 is in limited/reduced/adaptive availability/operation). In an embodiment, the one or more first TIDs comprise a first TID that corresponds to low-latency traffic or to urgent traffic. In an embodiment, frame 1106 may comprise one or more first fields that indicate the one or more first TIDs and/or the one or more first ACs. In an embodiment, the one or more first fields comprise a first field that indicates the one or more first TIDs. In an embodiment, the first field may comprise a TID bitmap with a respective bit for each downlink TID of STA 1104. In an implementation, the respective bit for a TID may be set to 1 in the TID bitmap to indicate that a PPDU comprising a data frame with the TID (i.e., a data frame comprising traffic associated with the TID) may be transmitted to STA 1104 during the period of unavailability of STA 1104 (or while STA 1104 is in limited/reduced/adaptive availability/operation). In an implementation, the respective bit for a TID may be set to 0 in the TID bitmap to indicate that a PPDU comprising a data frame with the TID may not be transmitted to STA 1104 during the period of unavailability of STA 1104 (or while STA 1104 is in limited/reduced/adaptive availability/operation). In another embodiment, the one or more first fields comprise a first field that indicates the one or more first ACs. In an embodiment, the first field may comprise an AC bitmap with a respective bit for each AC of AC_VO, AC_VI, AC_BE, or AC_BK. In an implementation, the respective bit for an AC may be set to 1 in the AC bitmap to indicate that a PPDU comprising a data frame with the AC (i.e., a data frame comprising traffic associated with the AC) may be transmitted to STA 1104 during the period of unavailability of STA 1104 (or while STA 1104 is in limited/reduced/adaptive availability/operation). In an implementation, the respective bit for an AC may be set to 0 in the AC bitmap to indicate that a PPDU comprising a data frame with the AC may not be transmitted to STA 1104 during the period of unavailability of STA 1104 (or while STA 1104 is in limited/reduced/adaptive availability/operation).

In an embodiment, based on receiving frame 1106, STA 1102 may be configured to refrain from transmitting to STA 1104 via the first channel (e.g., CH1) during the period of unavailability of STA 1104 (or while STA 1104 is in limited/reduced/adaptive availability/operation). In an embodiment, based on receiving frame 1106, STA 1102 may be configured to refrain from transmitting to STA 1104 via the second channel (e.g., CH2), during the period of unavailability of STA 1104 (or while STA 1104 is in limited/reduced/adaptive availability/operation), any PPDU that does not satisfy the condition indicated in frame 1106. Specifically, in example 1100, STA 1102 may be configured to refrain from transmitting to STA 1104 via the second channel, during the period of unavailability of STA 1104 (or while STA 1104 is in limited/reduced/adaptive availability/operation), any PPDU that does not comprise a data frame with a TID equal to the one of one or more first TIDs (e.g., x, y, z) and/or with an AC equal to the one of one or more first ACs (e.g., AC_VO, AC_VI).

Returning to FIG. 11, in an example, after transmitting frame 1106, STA 1104 may exchange one or more frames (not shown in FIG. 11) with STA 1102. For example, STA 1104 may communicate with STA 1102 to transmit and/or receive data to/from STA 1102.

Subsequently, the period of unavailability (or limited/reduced/adaptive availability/operation) of STA 1104 begins. In example 1100, after the period of unavailability (or limited/reduced/adaptive availability/operation) of STA 1104 begins, data for STA 1104 with a TID equal to TID x arrives at STA 1102. For example, TID x may correspond to low latency (LL) traffic that requires urgent transmission to STA 1104. Based on TID x being among the one or more first TIDs indicated in the condition indicated in frame 1106, STA 1102 may transmit to STA 1104, via the second channel and during the period of unavailability of STA 1104 (or while STA 1104 is in limited/reduced/adaptive availability/operation), a PPDU 1108 comprising a data frame with at least a portion of the data with the TID equal to TID x.

Subsequently, during the period of unavailability of STA 1104 (or while STA 1104 is in limited/reduced/adaptive availability/operation), data for STA 1104 with a TID equal to TID a arrives at STA 1102. Based on TID a not being among the one or more first TIDs indicated in the condition indicated in frame 1106, STA 1102 may refrain from transmitting, via the second channel and during the period of unavailability of STA 1104 (or while STA 1104 is in limited/reduced/adaptive availability/operation), a PPDU comprising a data frame with the TID equal to TID a. Instead, STA 1102 may wait until the end of the period of unavailability (or limited/reduced/adaptive availability/operation) of STA 1104 and may transmit to STA 1104, after the period of unavailability of STA 1104, a PPDU 1110 comprising a data frame with at least a portion of the data with the TID equal to TID a. In an embodiment, as shown in FIG. 11, STA 1102 may transmit PPDU 1110 via the first channel (e.g., CH1). Alternatively, STA 1102 may transmit PPDU 1110 via the second channel (e.g., CH2).

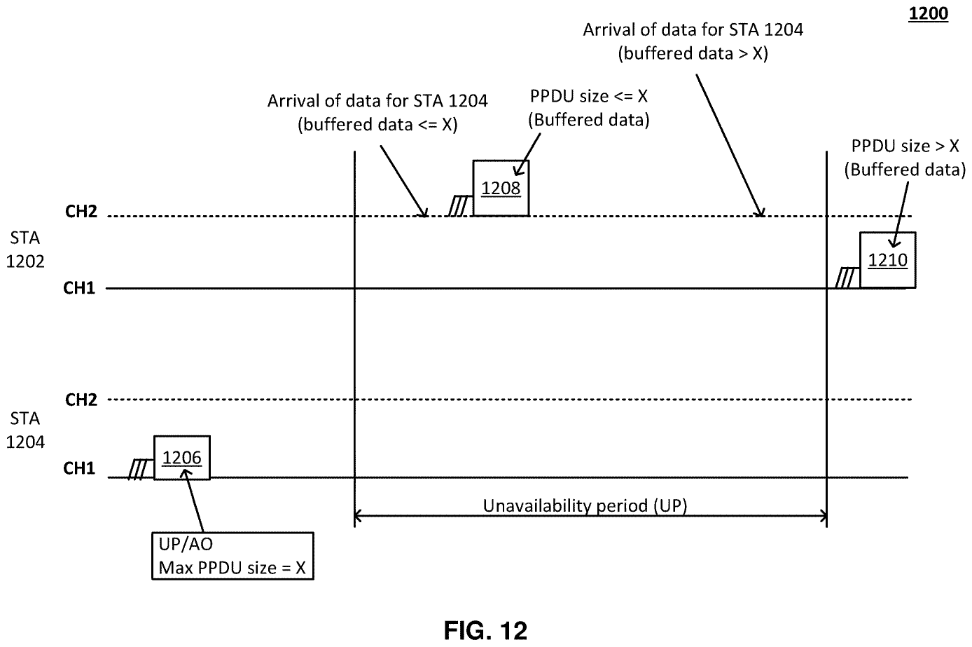

FIG. 12 illustrates an example 1200 of another procedure according to an embodiment. Example 1200 is provided for the purpose of illustration only and is not limiting of embodiments. As shown in FIG. 12, example 1200 includes a STA 1202 and a STA 1204. STA 1202 may be an AP STA or a non-AP STA. Similarly, STA 1204 may be an AP STA or a non-AP STA. In an embodiment, STA 1202 may be an AP STA, and STA 1204 may be a non-AP STA. STA 1204 may be associated with STA 1202. In another embodiment, STA 1202 may be a non-AP STA, and STA 1204 may be an AP STA. STA 1202 may be associated with STA 1204. STA 1202 and STA 1204 may operate over multiple channels, including a channel CH1 and a channel CH2. CH1 may comprise a primary channel of STA 1202. The primary channel of STA 1202 may comprise a 20 MHz primary channel, a 40 MHz primary channel, an 80 MHz primary channel, or a 160 MHz primary channel. CH2 may comprise a secondary channel of STA 1102. The secondary channel of STA 1102 may comprise a 20 MHz secondary channel, a 40 MHz secondary channel, an 80 MHz secondary channel, or a 160 MHz secondary channel. CH1 and CH2 may be adjacent, non-adjacent, or overlapping channels.

As shown in FIG. 12, example 1200 may begin with STA 1204 transmitting a frame 1206 to STA 1202. In embodiments, frame 1206 may comprise an ICF, an ICR, a request frame, a response frame, a control frame, a management frame, an action frame, a QoS null frame, or a QoS data frame, for example. In an embodiment, frame 1206 comprises an ICR transmitted by STA 1204 in response to an ICF frame from STA 1202. In an embodiment, the ICR transmitted by STA 1204 comprises a multi-STA BlockAck frame, and the ICF transmitted by STA 1202 comprises a BSRP Trigger frame. In an embodiment, STA 1202 transmits the ICF to initiate frame exchanges (that are neither group addressed Data nor group address Management frames) with STA 1204 when STA 1204 operates in a mode in which STA 1204 may inform another STA of its limited/reduced/adaptive availability/operation (e.g., Dynamic Unavailability Operation (DUO) mode, Periodic Unavailability Operation (PUO) mode, or Limited Operation Mode (LOM)). LOM may also be referred to as Adaptive Operation Mode (AOM). In LOM/AOM, a STA may reduce/adapt (or may request from an associated AP to reduce/adapt) parameters used for communication (transmission/reception) with the STA. In another embodiment, where STA 1204 is a TXOP holder, frame 1206 comprises a BSRP Trigger frame.

In an embodiment, frame 1206 may indicate a period of unavailability (or limited/reduced/adaptive availability/operation) of STA 1204. The period of unavailability (or limited/reduced/adaptive availability/operation) may be periodic or aperiodic. The period of unavailability (or limited/reduced/adaptive availability/operation) may be due to an IDC event within STA 1204. In an embodiment, frame 1206 may also indicate a first channel to which the period of unavailability (or limited/reduced/adaptive availability/operation) applies. In an embodiment, STA 1204 may be unavailable for communication via the first channel with other WLAN devices, including STA 1202, during at least a portion of the period of unavailability (or limited/reduced/adaptive availability/operation) to avoid the occurrence of an IDC interference event due to the IDC event. In example 1200, the first channel indicated in frame 1206 comprises CH1. In an embodiment, frame 1206 may further indicate a second channel to be used or that may be used by STA 1202 for transmission of a PPDU, during the period of unavailability of STA 1204 (or while STA 1204 is in limited/reduced/adaptive availability/operation), to STA 1204. In example 1200, the second channel indicated in frame 1206 comprises CH2. In an embodiment, frame 1206 indicates whether one or more channels that fall within a BSS bandwidth of the BSS of STA 1204 are enabled or disabled when STA 1204 operates in limited/reduced/adaptive availability/operation mode. In an embodiment, frame 1206 includes a channel bitmap with a respective bit for each channel indicating whether the channel is enabled/disabled when STA 1204 operates in limited/reduced/adaptive availability/operation mode. In an embodiment, frame 1206 indicates a start time and a duration for the period of unavailability (or limited/reduced/adaptive availability/operation).

In an embodiment, frame 1206 further indicates a condition for transmission of a PPDU by STA 1102 to STA 1204 during the period of unavailability of STA 1204 (or while STA 1204 is in limited/reduced/adaptive availability/operation) using the second channel (e.g., CH2 in example 1200). In other words, frame 1206 indicates that, notwithstanding the indicated period of unavailability (or limited/reduced/adaptive availability/operation) of STA 1204, a PPDU may be transmitted to STA 1204 using the second channel, during the period of unavailability of STA 1204 (or while STA 1204 is in limited/reduced/adaptive availability/operation), provided that the PPDU satisfies the condition indicated in frame 1206. In another embodiment, rather than indicating the condition for transmission to STA 1204 during the period of unavailability of STA 1204 (or while STA 1204 is in limited/reduced/adaptive availability/operation) in frame 1206, the condition may be indicated in another frame (not shown in FIG. 12) transmitted by STA 1204 to STA 1202 or may be pre-configured within STA 1202.

In an embodiment, as illustrated in FIG. 12, the condition comprises the PPDU having a size/duration smaller than or equal to a threshold (or a maximum PPDU size/duration) (e.g., X). In an embodiment, frame 1206 may include a field indicating the threshold (or the maximum PPDU size/duration).

In an embodiment, based on receiving frame 1206, STA 1202 may be configured to refrain from transmitting to STA 1204 via the first channel (e.g., CH1) during limited operation or the period of unavailability (or limited/reduced/adaptive availability/operation) of STA 1204. In an embodiment, based on receiving frame 1206, STA 1202 may be configured to refrain from transmitting to STA 1204 via the second channel (e.g., CH2), during the period of unavailability of STA 1204 (or while STA 1204 is in limited/reduced/adaptive availability/operation), any PPDU that does not satisfy the condition indicated in frame 1206. Specifically, in example 1200, STA 1102 may be configured to refrain from transmitting to STA 1204, during the period of unavailability of STA 1204 (or while STA 1204 is in limited/reduced/adaptive availability/operation), any PPDU that is larger than the threshold (or maximum PPDU size/duration) X indicated in frame 1206. In an embodiment, STA 1202 may be configured to apply this behavior as long as STA 1202 has not received from STA 1204 a frame indicating the availability of STA 1204.

Returning to FIG. 12, in an example, after transmitting frame 1206, STA 1104 may exchange one or more frames (not shown in FIG. 12) with STA 1102. For example, STA 1104 may communicate with STA 1102 to transmit and/or receive data to/from STA 1102.

Subsequently, the period of unavailability (or limited/reduced/adaptive availability/operation) of STA 1204 begins. In example 1200, after the period of unavailability (or limited/reduced/adaptive availability/operation) of STA 1204 begins, data for STA 1204 arrives at STA 1202. In an embodiment, STA 1202 may buffer the data for transmission to STA 1204. In an embodiment, STA 1202 may determine whether the buffered data can be transmitted in a PPDU with a size/duration smaller than or equal to the threshold X indicated in frame 1206.

In an embodiment, STA 1202 may be configured, if the buffered data can be transmitted (in its entirety) in a PPDU with a size/duration smaller than or equal to the threshold X, to transmit a PPDU with the buffered data to STA 1204 during the period of unavailability of STA 1204 (or while STA 1204 is in limited/reduced/adaptive availability/operation) using the second channel. This is illustrated in example 1200, in which the size/duration of the buffered data for STA 1204 is smaller than or equal to the threshold X and in which STA 1202 transmits the buffered data using the second channel, during the period of unavailability of STA 1204 (or while STA 1204 is in limited/reduced/adaptive availability/operation), in a PPDU 1208 with a size/duration smaller than or equal to X. Conversely, STA 1202 may be configured, if the buffered data cannot be transmitted (in its entirety) in a PPDU with a size/duration larger than the threshold X, to refrain from transmitting the buffered data during the period of unavailability of STA 1204 (or while STA 1204 is in limited/reduced/adaptive availability/operation). In example 1200, such a PPDU is transmitted after the period of unavailability (or limited/reduced/adaptive availability/operation) via PPDU 1210. In an embodiment, as shown in FIG. 12, STA 1202 may transmit PPDU 1210 via the first channel (e.g., CH1). Alternatively, STA 1202 may transmit PPDU 1210 via the second channel (e.g., CH2).

In another embodiment, STA 1202 may be configured, if the buffered data cannot be transmitted (in its entirety) in a PPDU with a size/duration larger than the threshold X, to fragment the buffered data into fragments that each can be carried in a PPDU with a size/duration smaller than or equal to the threshold X and to transmit one or more of the fragments in respective one or more PPDUs with a size/duration smaller than or equal to the threshold X.

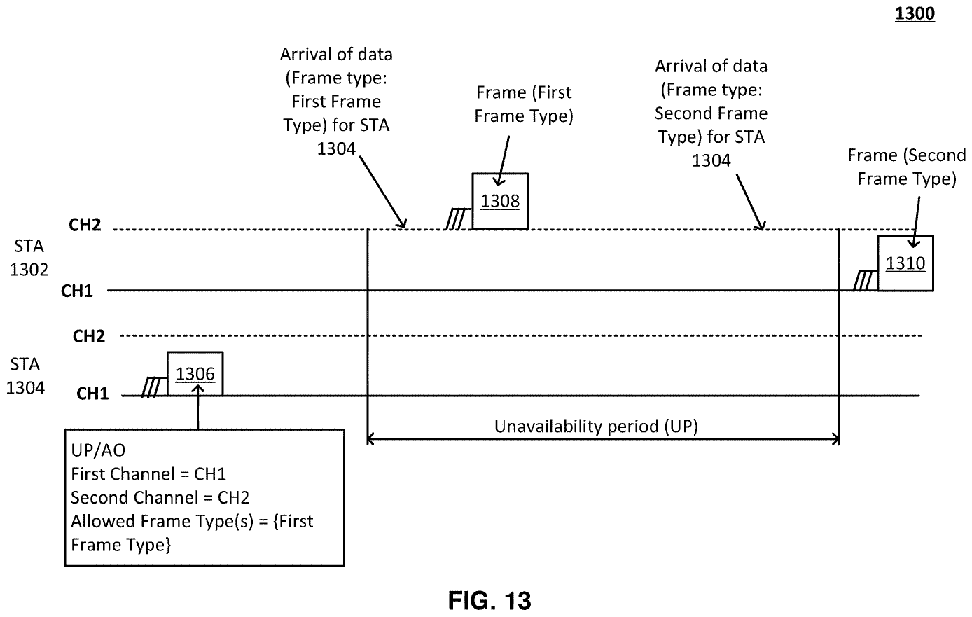

FIG. 13 illustrates an example 1300 of another procedure according to an embodiment. Example 1300 is provided for the purpose of illustration only and is not limiting of embodiments. As shown in FIG. 13, example 1300 includes a STA 1302 and a STA 1304. STA 1302 may be an AP STA or a non-AP STA. Similarly, STA 1304 may be an AP STA or a non-AP STA. In an embodiment, STA 1302 may be an AP STA, and STA 1304 may be a non-AP STA. STA 1304 may be associated with STA 1302. In another embodiment, STA 1302 may be a non-AP STA, and STA 1304 may be an AP STA. STA 1302 may be associated with STA 1304. STA 1302 and STA 1304 may operate over a plurality of channels, including a channel CH1 and a channel CH2. CH1 may comprise a primary channel of STA 1302. The primary channel of STA 1302 may comprise a 20 MHz primary channel, a 40 MHz primary channel, an 80 MHz primary channel, or a 160 MHz primary channel. CH2 may comprise a secondary channel of STA 1302. The secondary channel of STA 1302 may comprise a 20 MHz secondary channel, a 40 MHz secondary channel, an 80 MHz secondary channel, or a 160 MHz secondary channel. CH1 and CH2 may be adjacent, non-adjacent, or overlapping channels.

As shown in FIG. 13, example 1300 may begin with STA 1304 transmitting a frame 1306 to STA 1302. In embodiments, frame 1106 may comprise an ICF, an ICR, a request frame, a response frame, a control frame, a management frame, an action frame, a QoS null frame, or a QoS data frame, for example. In an embodiment, frame 1306 comprises an ICR transmitted by STA 1204 in response to an ICF frame from STA 1302. In an embodiment, the ICR transmitted by STA 1304 comprises a multi-STA BlockAck frame, and the ICF transmitted by STA 1302 comprises a BSRP Trigger frame. In an embodiment, STA 1302 transmits the ICF to initiate frame exchanges (that are neither group addressed Data nor group address Management frames) with STA 1304 when STA 1304 operates in a mode in which STA 1304 may inform another STA of its limited/reduced/adaptive availability/operation (e.g., Dynamic Unavailability Operation (DUO) mode, Periodic Unavailability Operation (PUO) mode, or Limited Operation Mode (LOM)). LOM may also be referred to as Adaptive Operation Mode (AOM). In LOM/AOM, a STA may reduce/adapt (or may request from an associated AP to reduce/adapt) parameters used for communication (transmission/reception) with the STA. In another embodiment, where STA 1304 is a TXOP holder, frame 1306 comprises a BSRP Trigger frame.

In an embodiment, frame 1306 may indicate a period of unavailability (or limited/reduced/adaptive availability/operation) of STA 1304. The period of unavailability (or limited/reduced/adaptive availability/operation) may be periodic or aperiodic. The period of unavailability (or limited/reduced/adaptive availability/operation) may be due to an IDC event within STA 1304. In an embodiment, frame 1306 may also indicate a first channel to which the period of unavailability (or limited/reduced/adaptive availability/operation) applies. In an embodiment, STA 1304 may be unavailable for communication via the first channel with other WLAN devices, including STA 1302, during at least a portion of the period of unavailability (or limited/reduced/adaptive availability/operation) to avoid the occurrence of an IDC interference event due to the IDC event. In example 1300, the first channel indicated in frame 1306 comprises CH1. In an embodiment, frame 1306 may further indicate a second channel to be used or that may be used by STA 1302 for transmission of a PPDU, during the period of unavailability of STA 1304 (or while STA 1304 is in limited/reduced/adaptive availability/operation), to STA 1304. In example 1300, the second channel indicated in frame 1306 comprises CH2. In an embodiment, frame 1306 indicates whether one or more channels that fall within a BSS bandwidth of the BSS of STA 1304 are enabled or disabled when STA 1304 operates in limited/reduced/adaptive availability/operation mode. In an embodiment, frame 1306 includes a channel bitmap with a respective bit for each channel indicating whether the channel is enabled/disabled when STA 1304 operates in limited/reduced/adaptive availability/operation mode. In an embodiment, frame 1306 indicates a start time and a duration for the period of unavailability (or limited/reduced/adaptive availability/operation).

In an embodiment, frame 1306 further indicates a condition for transmission of a PPDU by STA 1302 to STA 1304 during the period of unavailability of STA 1304 (or while STA 1304 is in limited/reduced/adaptive availability/operation) using the second channel (e.g., CH2 in example 1300). In other words, frame 1306 indicates that, notwithstanding the indicated period of unavailability (or limited/reduced/adaptive availability/operation) of STA 1304, a PPDU may be transmitted to STA 1304 using the second channel, during the period of unavailability (or while STA 1304 is in limited/reduced/adaptive availability/operation), provided that the PPDU satisfies the condition indicated in frame 1306. In another embodiment, rather than indicating the condition for transmission to STA 1304 during the period of unavailability of STA 1304 (or while STA 1304 is in limited/reduced/adaptive availability/operation) in frame 1306, the condition may be indicated in another frame (not shown in FIG. 13) transmitted by STA 1304 to STA 1302 or may be pre-configured within STA 1302.

In an embodiment, as illustrated in FIG. 13, the condition comprises the PPDU comprising a frame of a first frame type (allowed frame type). In an embodiment, frame 1306 may include a field indicating the first frame type. In an embodiment, the first frame type may comprise an ICF, an ICR, an RTS frame, a CTS frame, a multi-user (MU)-RTS frame, a buffer status report poll (BSRP) trigger frame, a BAR frame, a BA frame, a BSR frame, a control frame, or an action frame, for example. In an embodiment, the frame of the first frame type may be a frame that indicates that STA 1302 has buffered traffic for STA 1304. In an embodiment, the frame of the first frame type may comprise a traffic indication information (e.g., traffic indication map (TIM) element) that indicates that STA 1302 has buffered traffic for STA 1304. In another embodiment, the frame of the first frame type may further indicate a traffic type (e.g., TID, TID bitmap) or an AC of the buffered traffic.

In an embodiment, based on receiving frame 1306, STA 1302 may be configured to refrain from transmitting to STA 1304, during the period of unavailability of STA 1304 (or while STA 1304 is in limited/reduced/adaptive availability/operation), any PPDU that does not satisfy the condition indicated in frame 1306. Specifically, in example 1300, STA 1302 may be configured to refrain from transmitting to STA 1304, during the period of unavailability of STA 1304 (or while STA 1304 is in limited/reduced/adaptive availability/operation), any PPDU that does not include (or that does not include only) a frame of the first frame type. In an embodiment, STA 1302 may be configured to apply this behavior as long as STA 1302 has not received from STA 1304 a frame indicating the availability of STA 1304.

Returning to FIG. 13, in an example, after transmitting frame 1306, STA 1304 may exchange one or more frames (not shown in FIG. 13) with STA 1302. For example, STA 1304 may communicate with STA 1302 to transmit and/or receive data to/from STA 1302.

Subsequently, the period of unavailability (or limited/reduced/adaptive availability/operation) of STA 1304 begins. In example 1300, after the period of unavailability (or limited/reduced/adaptive availability/operation) of STA 1304 begins, a frame of the first frame type for STA 1304 arrives at STA 1302.

Based on the arriving frame type being among the one or more frame types indicated in the condition indicated in frame 1306, STA 1302 may transmit to STA 1304, during the period of unavailability (or limited/reduced/adaptive availability/operation) of STA 1304 and via the second channel, a PPDU 1308 comprising the frame of the first frame type.

Subsequently, during the period of unavailability of STA 1304 (or while STA 1304 is in limited/reduced/adaptive availability/operation), a frame of a second frame type for STA 1304 arrives at STA 1302. Based on the arriving frame type not being among the one or more frame types indicated in the condition indicated in frame 1306, STA 1302 may refrain from transmitting, via the second channel and during the period of unavailability of STA 1304 (or while STA 1304 is in limited/reduced/adaptive availability/operation), a PPDU comprising the frame of the second frame type. Instead, STA 1302 may wait until the end of the period of unavailability (or limited/reduced/adaptive availability/operation) of STA 1304 and may transmit to STA 1304, after the period of unavailability (or limited/reduced/adaptive availability/operation) of STA 1304, a PPDU 1310 comprising the frame of the second frame type. In an embodiment, as shown in FIG. 13, STA 1302 may transmit PPDU 1310 via the first channel (e.g., CH1). Alternatively, STA 1302 may transmit PPDU 1310 via the second channel (e.g., CH2).

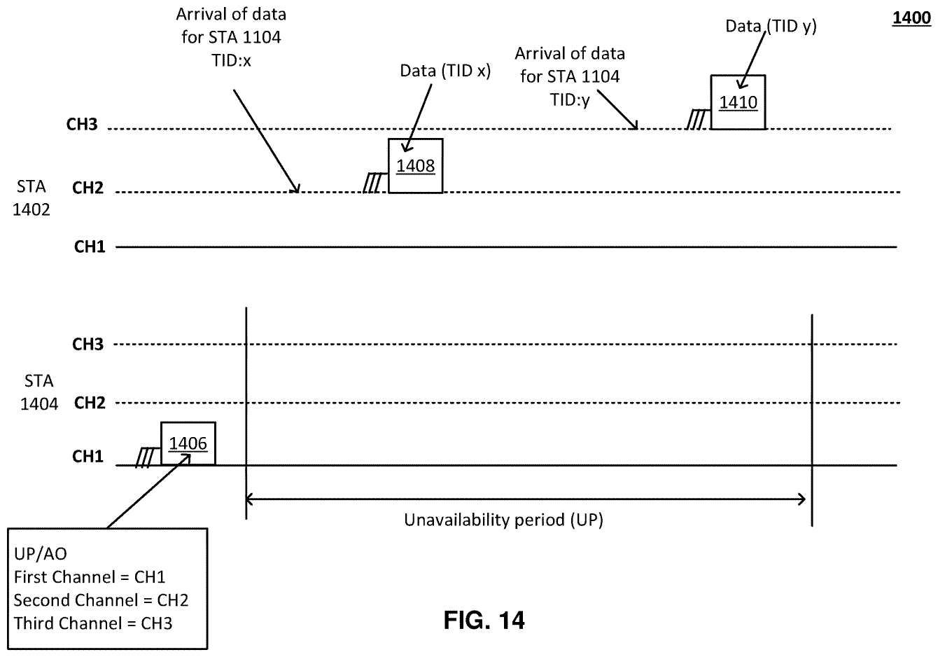

FIG. 14 illustrates an example 1400 of another procedure according to an embodiment. Example 1400 is provided for the purpose of illustration only and is not limiting of embodiments. As shown in FIG. 14, example 1400 includes a STA 1402 and a STA 1404. STA 1402 may be an AP STA or a non-AP STA. Similarly, STA 1404 may be an AP STA or a non-AP STA. In an embodiment, STA 1402 may be an AP STA, and STA 1404 may be a non-AP STA. STA 1404 may be associated with STA 1402. In another embodiment, STA 1402 may be a non-AP STA, and STA 1404 may be an AP STA. STA 1402 may be associated with STA 1404. STA 1402 and STA 1404 may operate on a plurality of channels, including CH1, CH2, and CH3. CH1 may comprise a primary channel of STA 1402. The primary channel of STA 1402 may comprise a 20 MHz primary channel, a 40 MHz primary channel, an 80 MHz primary channel, or a 160 MHz primary channel. CH2 and CH3 may each comprise a secondary channel of STA 1402. The secondary channel of STA 1402 may comprise a 20 MHz secondary channel, a 40 MHz secondary channel, an 80 MHz secondary channel, or a 160 MHz secondary channel. As shown in FIG. 14, CH1 may be adjacent to CH2, which may be adjacent to CH3. CH1 may be non-adjacent to CH3.

As shown in FIG. 14, example 1400 may begin with STA 1404 transmitting a frame 1406 to STA 1402. In embodiments, frame 1406 may comprise an initial control frame (ICF) an initial control response frame (ICR), a request frame, a response frame, a control frame, a management frame, an action frame, a QoS null frame, or a QoS data frame, for example. In an embodiment, frame 1406 comprises an ICR transmitted by STA 1404 in response to an ICF frame from STA 1402. In an embodiment, the ICR transmitted by STA 1404 comprises a multi-STA BlockAck frame, and the ICF transmitted by STA 1402 comprises a BSRP Trigger frame. In an embodiment, STA 1402 transmits the ICF to initiate frame exchanges (that are neither group addressed Data nor group address Management frames) with STA 1404 when STA 1404 operates in a mode in which STA 1404 may inform another STA of its limited/reduced/adaptive availability/operation (e.g., Dynamic Unavailability Operation (DUO) mode, Periodic Unavailability Operation (PUO) mode, or Limited Operation Mode (LOM)). LOM may also be referred to as Adaptive Operation Mode (AOM). In LOM/AOM, a STA may reduce/adapt (or may request from an associated AP to reduce/adapt) parameters used for communication (transmission/reception) with the STA. In another embodiment, where STA 1404 is a TXOP holder, frame 1406 comprises a BSRP Trigger frame.

In an embodiment, frame 1406 may indicate a period of unavailability (or limited/reduced/adaptive availability/operation) of STA 1404. The period of unavailability (or limited/reduced/adaptive availability/operation) may be periodic or aperiodic. The period of unavailability (or limited/reduced/adaptive availability/operation) may be due to an IDC event within STA 1404. In an embodiment, frame 1406 may also indicate a first channel to which the period of unavailability (or limited/reduced/adaptive availability/operation) applies. In an embodiment, STA 1404 may be unavailable for communication via the first channel with other WLAN devices, including STA 1402, during at least a portion of the period of unavailability (or limited/reduced/adaptive availability/operation) to avoid the occurrence of an IDC interference event due to the IDC event. In example 1400, the first channel indicated in frame 1406 comprises CH1. In an embodiment, frame 1406 may further indicate a second channel to be used or that may be used by STA 1402 for transmission of a PPDU, during the period of unavailability of STA 1404 (or while STA 1404 is in limited/reduced/adaptive availability/operation), to STA 1404. In example 1400, the second channel indicated in frame 1406 comprises CH2. In an embodiment, frame 1406 may further indicate a third channel to be used or that may be used by STA 1402 for transmission of a PPDU, during the period of unavailability of STA 1404 (or while STA 1404 is in limited/reduced/adaptive availability/operation), to STA 1404. In example 1400, the third channel indicated in frame 1406 comprises CH3. In an embodiment, frame 1406 indicates whether one or more channels that fall within a BSS bandwidth of the BSS of STA 1404 are enabled or disabled when STA 1404 operates in limited/reduced/adaptive availability/operation mode. In an embodiment, frame 1406 includes a channel bitmap with a respective bit for each channel indicating whether the channel is enabled/disabled when STA 1404 operates in limited/reduced/adaptive availability/operation mode. In an embodiment, frame 1406 indicates a start time and a duration for the period of unavailability (or limited/reduced/adaptive availability/operation).

In an embodiment, frame 1406 further indicates a condition for transmission of a PPDU by STA 1402 to STA 1404 during the period of unavailability of STA 1404 (or while STA 1404 is in limited/reduced/adaptive availability/operation) using the second/third channel (e.g., CH2/CH3 in example 1400). In other words, frame 1406 indicates that, notwithstanding the indicated period of unavailability (or limited/reduced/adaptive availability/operation) of STA 1404, a PPDU may be transmitted to STA 1404 using the second/third channel, during the period of unavailability of STA 1404 (or while STA 1404 is in limited/reduced/adaptive availability/operation), provided that the PPDU satisfies the condition indicated in frame 1406. In another embodiment, rather than indicating the condition for transmission to STA 1404 during the period of unavailability of STA 1404 (or while STA 1404 is in limited/reduced/adaptive availability/operation) in frame 1406, the condition may be indicated in another frame (not shown in FIG. 14) transmitted by STA 1404 to STA 1402 or may be pre-configured within STA 1402.

In an embodiment, the condition for transmission of a PPDU to STA 1404 via a channel other than the first channel, during the period of unavailability of STA 1404 (or while STA 1404 is in limited/reduced/adaptive availability/operation), may be based on a position of the other channel relative to the first channel. For example, in an embodiment, the condition comprises the PPDU comprising a data frame with a traffic identifier (TID) equal to a first TID or with an access category (AC) equal to a first AC. When the other channel is adjacent/overlapping to the first channel, the first TID may be associated with low latency (LL) traffic and the first AC may comprise AC_VO and AC_VI (and may not comprise AC_BE and AC_BK). Conversely, when the other channel is non-adjacent to the first channel, the first TID may be associated with non-low latency (non-LL) traffic or LL traffic and the first AC may comprise AC_BE or AC_BK (in addition to AC_VO and AC_VI, for example). This is illustrated further below.

Returning to example 1400, after transmitting frame 1406, STA 1404 may exchange one or more frames (not shown in FIG. 14) with STA 1402. For example, STA 1404 may communicate with STA 1402 to transmit and/or receive data to/from STA 1402.

Subsequently, the period of unavailability (or limited/reduced/adaptive availability/operation) of STA 1404 begins. In example 1400, after the period of unavailability (or limited/reduced/adaptive availability/operation) of STA 1404 begins, data for STA 1404 with a TID equal to TID x arrives at STA 1402. For example, TID x may correspond to low latency (LL) traffic that requires urgent transmission to STA 1404. In an embodiment, based on the second channel (CH2) being adjacent to the first channel (CH1), the condition for transmitting a PPDU via the second channel (CH2) to STA 1404, during the period of unavailability of STA 1404 (or while STA 1404 is in limited/reduced/adaptive availability/operation), may comprise the PPDU comprising a data frame with TID x (e.g., corresponding to LL traffic). In an embodiment, based on the third channel (CH3) being non-adjacent to the first channel (CH1), the condition for transmitting a PPDU via the second channel (CH2) to STA 1404, during the period of unavailability of STA 1404 (or while STA 1404 is in limited/reduced/adaptive availability/operation), may comprise the PPDU comprising a data frame with TID x or with TID y (corresponding to non-LL traffic). As such, based on the data arriving for STA 1404 being of TID x, STA 1402 may determine that STA 1402 may transmit a PPDU comprising the data via either the second channel (CH2) or the third channel (CH3) during the period of unavailability of STA 1404 (or while STA 1404 is in limited/reduced/adaptive availability/operation). In example 1400, STA 1402 may choose to transmit the data via the second channel and may transmit a PPDU 1408 comprising a data frame with at least a portion of the data with the TID equal to TID x.

Subsequently, in an example, data for STA 1404 with a TID equal to TID y arrives at STA 1402. Based on the data arriving for STA 1404 being of TID y (corresponding to non-LL traffic), STA 1402 may determine that STA 1402 may transmit a PPDU comprising the data via the third channel (CH3), but not via the second channel (CH2), during the period of unavailability of STA 1404 (or while STA 1404 is in limited/reduced/adaptive availability/operation). As such, as shown in example 1400, STA 1402 may transmit via the third channel a PPDU 1408 comprising a data frame with at least a portion of the data with the TID equal to TID y.

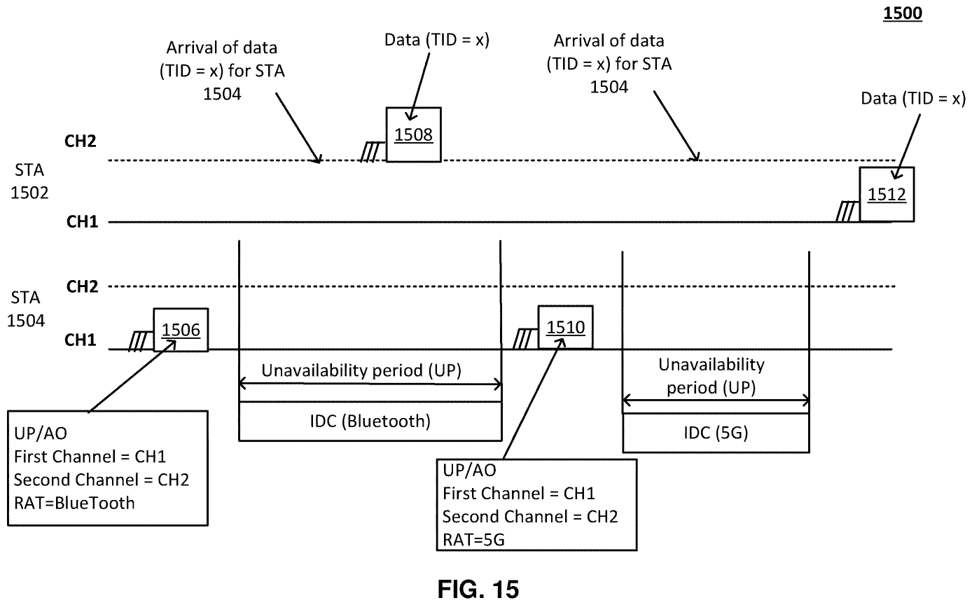

FIG. 15 illustrates an example 1500 of another procedure according to an embodiment. Example 1500 is provided for the purpose of illustration only and is not limiting of embodiments. As shown in FIG. 15, example 1500 includes a STA 1502 and a STA 1504. STA 1502 may be an AP STA or a non-AP STA. Similarly, STA 1504 may be an AP STA or a non-AP STA. In an embodiment, STA 1502 may be an AP STA, and STA 1504 may be a non-AP STA. STA 1504 may be associated with STA 1502. In another embodiment, STA 1502 may be a non-AP STA, and STA 1504 may be an AP STA. STA 1502 may be associated with STA 1504. STA 1502 and STA 1504 may operate on a plurality of channels, including CH1, CH2. CH1 may comprise a primary channel of STA 1502. The primary channel of STA 1502 may comprise a 20 MHz primary channel, a 40 MHz primary channel, an 80 MHz primary channel, or a 160 MHz primary channel. CH2 may comprise a secondary channel of STA 1402. The secondary channel of STA 1402 may comprise a 20 MHz secondary channel, a 40 MHz secondary channel, an 80 MHz secondary channel, or a 160 MHz secondary channel.

As shown in FIG. 15, example 1500 may begin with STA 1504 transmitting a frame 1506 to STA 1502. In embodiments, frame 1506 may comprise an initial control frame (ICF) an initial control response frame (ICR), a request frame, a response frame, a control frame, a management frame, an action frame, a QoS null frame, or a QoS data frame, for example. In an embodiment, frame 1506 comprises an ICR transmitted by STA 1504 in response to an ICF frame from STA 1502. In an embodiment, the ICR transmitted by STA 1504 comprises a multi-STA BlockAck frame, and the ICF transmitted by STA 1502 comprises a BSRP Trigger frame. In an embodiment, STA 1502 transmits the ICF to initiate frame exchanges (that are neither group addressed Data nor group address Management frames) with STA 1504 when STA 1504 operates in a mode in which STA 1504 may inform another STA of its limited/reduced/adaptive availability/operation (e.g., Dynamic Unavailability Operation (DUO) mode, Periodic Unavailability Operation (PUO) mode, or Limited Operation Mode (LOM). LOM may also be referred to as Adaptive Operation Mode (AOM). In LOM/AOM, a STA may reduce/adapt (or may request from an associated AP to reduce/adapt) parameters used for communication (transmission/reception) with the STA. In another embodiment, where STA 1504 is a TXOP holder, frame 1506 comprises a BSRP Trigger frame.

In an embodiment, frame 1506 may indicate a period of unavailability (or limited/reduced/adaptive availability/operation) of STA 1504. The period of unavailability (or limited/reduced/adaptive availability/operation) may be periodic or aperiodic. The period of unavailability (or limited/reduced/adaptive availability/operation) may be due to an IDC event within STA 1504. In an embodiment, frame 1506 may also indicate a first channel to which the period of unavailability (or limited/reduced/adaptive availability/operation) applies. In an embodiment, STA 1504 may be unavailable for communication via the first channel with other WLAN devices, including STA 1502, during at least a portion of the period of unavailability (or limited/reduced/adaptive availability/operation) to avoid the occurrence of an IDC interference event due to the IDC event. In example 1500, the first channel indicated in frame 1506 comprises CH1. In an embodiment, frame 1506 may further indicate a second channel to be used or that may be used by STA 1502 for transmission of a PPDU, during the period of unavailability of STA 1504 (or while STA 1504 is in limited/reduced/adaptive availability/operation), to STA 1504. In example 1500, the second channel indicated in frame 1506 comprises CH2. In an embodiment, frame 1506 indicates whether one or more channels that fall within a BSS bandwidth of the BSS of STA 1504 are enabled or disabled when STA 1504 operates in limited/reduced/adaptive availability/operation mode. In an embodiment, frame 1506 includes a channel bitmap with a respective bit for each channel indicating whether the channel is enabled/disabled when STA 1504 operates in limited/reduced/adaptive availability/operation mode. In an embodiment, frame 1506 indicates a start time and a duration for the period of unavailability (or limited/reduced/adaptive availability/operation). In an embodiment, frame 1506 may further indicate the type of the radio access technology (RAT) being used during the IDC event to which the period of unavailability (or limited/reduced/adaptive availability/operation) applies. In example 1500, the RAT indicated in frame 1506 is Bluetooth.

In an embodiment, frame 1506 further indicates a condition for transmission of a PPDU by STA 1502 to STA 1504 during the period of unavailability of STA 1504 (or while STA 1504 is in limited/reduced/adaptive availability/operation) using the second channel (e.g., CH2 in example 1500). In other words, frame 1506 indicates that, notwithstanding the indicated period of unavailability (or limited/reduced/adaptive availability/operation) of STA 1504, a PPDU may be transmitted to STA 1504 using the second channel, during the period of unavailability of STA 1504 (or while STA 1504 is in limited/reduced/adaptive availability/operation), provided that the PPDU satisfies the condition indicated in frame 1506. In another embodiment, rather than indicating the condition for transmission to STA 1504 during the period of unavailability of STA 1504 (or while STA 1504 is in limited/reduced/adaptive availability/operation) in frame 1506, the condition may be indicated in another frame (not shown in FIG. 15) transmitted by STA 1504 to STA 1502 or may be pre-configured within STA 1502.

In an embodiment, the condition for transmission of a PPDU to STA 1504 via a channel other than the first channel, during the period of unavailability of STA 1504 (or while STA 1504 is in limited/reduced/adaptive availability/operation), may be based on a type of the radio access technology (RAT) being used during the IDC event (to which the period of unavailability (or limited/reduced/adaptive availability/operation) of STA 1504 is due). For example, the RAT to which the IDC event is due may comprise, without limitation, Bluetooth®, Lightwave communication, 5G/6G, NR, or Ultrawideband (UWB), for example. For example, in an embodiment, the condition comprises the PPDU comprising a data frame with a traffic identifier (TID) equal to a first TID or with an access category (AC) equal to a first AC. When the RAT (used during the IDC event) is a first communication technology, the first TID may be associated with low latency (LL) traffic and the first AC may comprise AC_VO and AC_VI (and may not comprise AC_BE and AC_BK). Conversely, when the RAT (used during the IDC event) is a second communication technology, the first TID may be associated with non-low latency (non-LL) traffic or LL traffic and the first AC may comprise AC_BE or AC_BK (in addition to AC_VO and AC_VI, for example). This is illustrated further below.

Returning to example 1500, after transmitting frame 1506, STA 1504 may exchange one or more frames (not shown in FIG. 15) with STA 1502. For example, STA 1504 may communicate with STA 1502 to transmit and/or receive data to/from STA 1502.

Subsequently, the period of unavailability (or limited/reduced/adaptive availability/operation) of STA 1504 begins. In example 1500, after the period of unavailability (or limited/reduced/adaptive availability/operation) of STA 1504 begins, data for STA 1504 with a TID equal to TID x arrives at STA 1502. For example, TID x may correspond to low latency (LL) traffic that requires urgent transmission to STA 1504. In an embodiment, the condition for transmitting a PPDU via the second channel (e.g., CH2) to STA 1504, during the period of unavailability of STA 1504 (or while STA 1504 is in limited/reduced/adaptive availability/operation), may comprise, if the type of the RAT (used during the IDC event) is Bluetooth, a PPDU comprising a data frame with TID x (e.g., non-LL) or TID y (e.g., LL) may be transmitted via the second channel. As such, based on the data arriving for STA 1504 being of TID x and the other RAT being Bluetooth, STA 1502 may determine that STA 1502 may transmit a PPDU comprising the data via the second channel (CH2) during the period of unavailability of STA 1504 (or while STA 1504 is in limited/reduced/adaptive availability/operation). In example 1500, STA 1502 may transmit a PPDU 1508 comprising a data frame with at least a portion of the data with the TID equal to TID x.

Subsequently, STA 1502 may transmit a frame 1510. In an embodiment, frame 1510 may indicate a period of unavailability (or limited/reduced/adaptive availability/operation) of STA 1504. The period of unavailability (or limited/reduced/adaptive availability/operation) may be due to an IDC event within STA 1504. In an embodiment, frame 1510 may also indicate a first channel to which the period of unavailability (or limited/reduced/adaptive availability/operation) applies. In an embodiment, STA 1504 may be unavailable for communication via the first channel with other WLAN devices, including STA 1502, during at least a portion of the period of unavailability (or limited/reduced/adaptive availability/operation) to avoid the occurrence of an IDC interference event due to the IDC event. In example 1500, the first channel indicated in frame 1510 comprises CH1. In an embodiment, frame 1510 may further indicate a second channel to be used by STA 1502 for transmission of a PPDU, during the period of unavailability of STA 1504 (or while STA 1504 is in limited/reduced/adaptive availability/operation), to STA 1504. In example 1500, the second channel indicated in frame 1510 comprises CH2. In an embodiment, frame 1510 may further indicate the type of the RAT being used during the IDC event to which the period of unavailability (or limited/reduced/adaptive availability/operation) is due. In example 1500, the RAT indicated in frame 1510 is 5G.

After transmitting frame 1506, STA 1504 may exchange one or more frames (not shown in FIG. 15) with STA 1502. For example, STA 1504 may communicate with STA 1502 to transmit and/or receive data to/from STA 1502.

Subsequently, the period of unavailability (or limited/reduced/adaptive availability/operation) of STA 1504 begins. In example 1500, after the period of unavailability (or limited/reduced/adaptive availability/operation) of STA 1504 begins, data for STA 1504 with a TID equal to TID x arrives at STA 1502. In an embodiment, the condition for transmitting a PPDU via the second channel (e.g., CH2) to STA 1504, during the period of unavailability of STA 1504 (or while STA 1504 is in limited/reduced/adaptive availability/operation), may comprise, if the type of the RAT being used during the IDC event is 5G, a PPDU comprising a data frame with TID y (e.g., LL traffic) may be transmitted. As such, based on the data arriving for STA 1504 being of TID x (e.g., non-LL) and the other RAT being 5G, STA 1502 may determine that STA 1502 may not transmit the data via the second channel during the period of unavailability of STA 1504 (or while STA 1504 is in limited/reduced/adaptive availability/operation). Instead, STA 1502 may wait until the end of the period of unavailability (or limited/reduced/adaptive availability/operation) of STA 1504 and may transmit to STA 1504, after the period of unavailability (or limited/reduced/adaptive availability/operation) of STA 1504, a PPDU 1512 comprising the data with TID x. In an embodiment, as shown in FIG. 15, STA 1502 may transmit PPDU 1512 via the first channel (e.g., CH1). Alternatively, STA 1502 may transmit PPDU 1512 via the second channel (e.g., CH2).

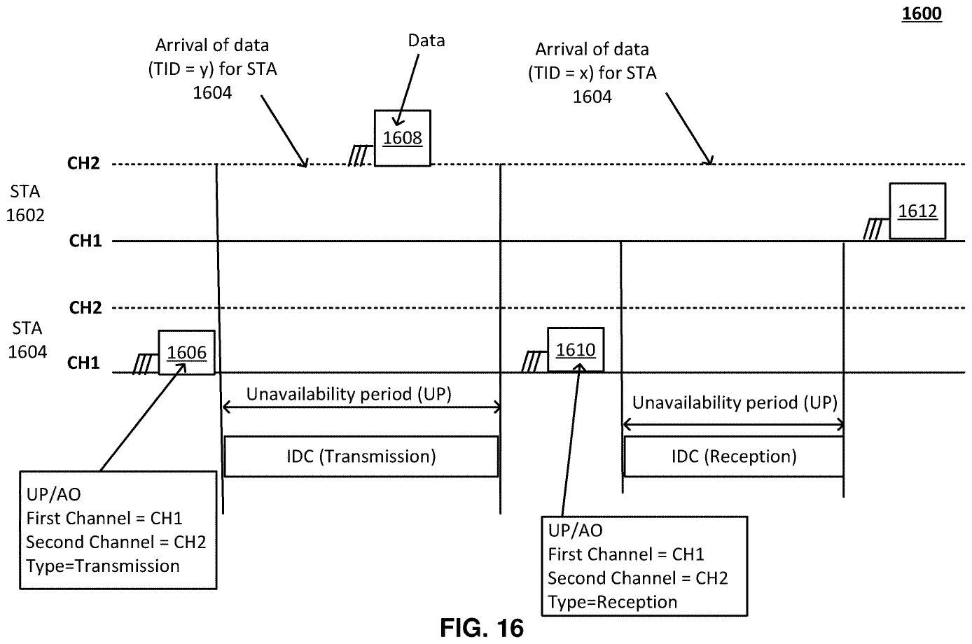

FIG. 16 illustrates an example 1600 of a procedure according to an embodiment. Example 1600 is provided for the purpose of illustration only and is not limiting of embodiments. As shown in FIG. 16, example 1600 includes a STA 1602 and a STA 1604. STA 1602 may be an AP STA or a non-AP STA. Similarly, STA 1604 may be an AP STA or a non-AP STA. In an embodiment, STA 1602 may be an AP STA, and STA 1604 may be a non-AP STA. STA 1604 may be associated with STA 1602. In another embodiment, STA 1602 may be a non-AP STA, and STA 1604 may be an AP STA. STA 1602 may be associated with STA 1604. STA 1602 and STA 1604 may operate on a plurality of channels, including CH1, CH2. CH1 may comprise a primary channel of STA 1602. The primary channel of STA 1602 may comprise a 20 MHz primary channel, a 40 MHz primary channel, an 80 MHz primary channel, or a 160 MHz primary channel. CH2 may comprise a secondary channel of STA 1402. The secondary channel of STA 1602 may comprise a 20 MHz secondary channel, a 40 MHz secondary channel, an 80 MHz secondary channel, or a 160 MHz secondary channel.

As shown in FIG. 16, example 1600 may begin with STA 1604 transmitting a frame 1606 to STA 1602. In embodiments, frame 1606 may comprise an initial control frame (ICF) an initial control response frame (ICR), a request frame, a response frame, a control frame, a management frame, an action frame, a QoS null frame, or a QoS data frame, for example. In an embodiment, frame 1606 comprises an ICR transmitted by STA 1604 in response to an ICF frame from STA 1602. In an embodiment, the ICR transmitted by STA 1604 comprises a multi-STA BlockAck frame, and the ICF transmitted by STA 1602 comprises a BSRP Trigger frame. In an embodiment, STA 1602 transmits the ICF to initiate frame exchanges (that are neither group addressed Data nor group address Management frames) with STA 1604 when STA 1604 operates in a mode in which STA 1604 may inform another STA of its limited/reduced/adaptive availability/operation (e.g., Dynamic Unavailability Operation (DUO) mode, Periodic Unavailability Operation (PUO) mode, or Limited Operation Mode (LOM). LOM may also be referred to as Adaptive Operation Mode (AOM). In LOM/AOM, a STA may reduce/adapt (or may request from an associated AP to reduce/adapt) parameters used for communication (transmission/reception) with the STA. In another embodiment, where STA 1604 is a TXOP holder, frame 1606 comprises a BSRP Trigger frame.

In an embodiment, frame 1606 may indicate a period of unavailability (or limited/reduced/adaptive availability/operation) of STA 1604. The period of unavailability (or limited/reduced/adaptive availability/operation) may be periodic or aperiodic. The period of unavailability (or limited/reduced/adaptive availability/operation) may be due to an IDC event within STA 1604. In an embodiment, frame 1606 may also indicate a first channel to which the period of unavailability (or limited/reduced/adaptive availability/operation) applies. In an embodiment, STA 1604 may be unavailable for communication via the first channel with other WLAN devices, including STA 1602, during at least a portion of the period of unavailability (or limited/reduced/adaptive availability/operation) to avoid the occurrence of an IDC interference event due to the IDC event. In example 1600, the first channel indicated in frame 1606 comprises CH1. In an embodiment, frame 1606 may further indicate a second channel to be used or that may be used by STA 1602 for transmission of a PPDU, during the period of unavailability of STA 1604 (or while STA 1604 is in limited/reduced/adaptive availability/operation), to STA 1604. In example 1600, the second channel indicated in frame 1606 comprises CH2. In an embodiment, frame 1606 indicates whether one or more channels that fall within a BSS bandwidth of the BSS of STA 1604 are enabled or disabled when STA 1604 operates in limited/reduced/adaptive availability/operation mode. In an embodiment, frame 1606 includes a channel bitmap with a respective bit for each channel indicating whether the channel is enabled/disabled when STA 1604 operates in limited/reduced/adaptive availability/operation mode. In an embodiment, frame 1606 indicates a start time and a duration for the period of unavailability (or limited/reduced/adaptive availability/operation). In an embodiment, frame 1606 may further indicate the type of the communication event occurring during the IDC event to which the period is due. In example 1600, the communication event indicated in frame 1606 is a transmission event (i.e., STA 1604 will transmit during the period of unavailability (or while STA 1604 is in limited/reduced/adaptive availability/operation) using another RAT).

In an embodiment, frame 1606 further indicates a condition for transmission of a PPDU by STA 1602 to STA 1604 during the period of unavailability of STA 1604 (or while STA 1604 is in limited/reduced/adaptive availability/operation) using the second channel (e.g., CH2 in example 1600). In other words, frame 1606 indicates that, notwithstanding the indicated period of unavailability (or limited/reduced/adaptive availability/operation) of STA 1604, a PPDU may be transmitted to STA 1604 using the second channel, during the period of unavailability of STA 1606 (or while STA 1604 is in limited/reduced/adaptive availability/operation), provided that the PPDU satisfies the condition indicated in frame 1606. In another embodiment, rather than indicating the condition for transmission to STA 1604 during the period of unavailability of STA 1604 (or while STA 1604 is in limited/reduced/adaptive availability/operation) in frame 1606, the condition may be indicated in another frame (not shown in FIG. 16) transmitted by STA 1604 to STA 1602 or may be pre-configured within STA 1602.

In an embodiment, the condition for transmission of a PPDU to STA 1604 via a channel other than the first channel, during the period of unavailability of STA 1604 (or while STA 1604 is in limited/reduced/adaptive availability/operation), may be based on the type of the communication event occurring during the IDC event (to which the period of unavailability (or limited/reduced/adaptive availability/operation) of STA 1604 is due). For example, in an embodiment, the condition comprises the PPDU comprising a data frame with a traffic identifier (TID) equal to a first TID or with an access category (AC) equal to a first AC. When the communication event (occurring during the IDC event) is of a first type (e.g., reception event), the first TID may be associated with low latency (LL) traffic (and may not comprise non-LL traffic) and the first AC may comprise AC_VO and AC_VI (and may not comprise AC_BE and AC_BK). Conversely, when the communication event is of a second type (e.g., transmission event), the first TID may be associated with non-low latency (non-LL) traffic or with LL traffic and the first AC may comprise AC_BE or AC_BK (in addition to AC_VO and AC_VI, for example). This is illustrated further below.

Returning to example 1600, after transmitting frame 1606, STA 1504 may exchange one or more frames (not shown in FIG. 16) with STA 1602. For example, STA 1604 may communicate with STA 1602 to transmit and/or receive data to/from STA 1602.

Subsequently, the period of unavailability (or limited/reduced/adaptive availability/operation) of STA 1604 begins. In example 1600, after the period of unavailability (or limited/reduced/adaptive availability/operation) of STA 1604 begins, data for STA 1604 with a TID equal to TID y arrives at STA 1602. For example, TID y may correspond to low latency (LL) traffic that requires urgent transmission to STA 1604. In an embodiment, the condition for transmitting a PPDU via the second channel (e.g., CH2) to STA 1604, during the period of unavailability of STA 1604 (or while STA 1604 is in limited/reduced/adaptive availability/operation), may comprise, if the communication event (occurring during the IDC event) is a transmission event, the PPDU comprising a data frame with TID x (e.g., non-LL) or TID y (e.g., LL). That is, any traffic type may be transmitted to STA 1604 over the second channel if the communication event (occurring during the IDC event) is a transmission event. As such, based on the data arriving for STA 1604 being of TID y and the communication event (occurring during the IDC event) being a transmission event, STA 1602 may determine that STA 1602 may transmit a PPDU comprising the data with TID y via the second channel (CH2) during the period of unavailability of STA 1604 (or while STA 1604 is in limited/reduced/adaptive availability/operation). In example 1600, STA 1602 may transmit a PPDU 1608 comprising a data frame with at least a portion of the data with the TID equal to TID y.

Subsequently, STA 1602 may transmit a frame 1610. In an embodiment, frame 1610 may indicate a period of unavailability (or limited/reduced/adaptive availability/operation) of STA 1604. The period of unavailability (or limited/reduced/adaptive availability/operation) may be due to an IDC event within STA 1604. In an embodiment, frame 1610 may also indicate a first channel to which the period of unavailability (or limited/reduced/adaptive availability/operation) applies. In an embodiment, STA 1604 may be unavailable for communication via the first channel with other WLAN devices, including STA 1602, during at least a portion of the period of unavailability (or limited/reduced/adaptive availability/operation) to avoid the occurrence of an IDC interference event due to the IDC event. In example 1600, the first channel indicated in frame 1610 comprises CH1. In an embodiment, frame 1610 may further indicate a second channel to be used by STA 1602 for transmission of a PPDU, during the period of unavailability of STA 1604 (or while STA 1604 is in limited/reduced/adaptive availability/operation), to STA 1604. In example 1600, the second channel indicated in frame 1610 comprises CH2. In an embodiment, frame 1610 may further indicate the type of the communication event occurring during the IDC event to which the period of unavailability (or limited/reduced/adaptive availability/operation) is due. In example 1600, the communication event indicated in frame 1610 is a reception event (i.e., STA 1604 will receive during the period of unavailability (or while STA 1604 is in limited/reduced/adaptive availability/operation) using another RAT).

In an embodiment, frame 1610 further indicates a condition for transmission of a PPDU by STA 1602 to STA 1604 during the period of unavailability of STA 1604 (or while STA 1604 is in limited/reduced/adaptive availability/operation) using the second channel (e.g., CH2 in example 1600). In other words, frame 1610 indicates that, notwithstanding the indicated period of unavailability (or limited/reduced/adaptive availability/operation) of STA 1604, a PPDU may be transmitted to STA 1604 using the second channel, during the period of unavailability of STA 1604 (or while STA 1604 is in limited/reduced/adaptive availability/operation), provided that the PPDU satisfies the condition indicated in frame 1610. In another embodiment, rather than indicating the condition for transmission to STA 1604 during the period of unavailability of STA 1604 (or while STA 1604 is in limited/reduced/adaptive availability/operation) in frame 1610, the condition may be indicated in another frame (not shown in FIG. 16) transmitted by STA 1604 to STA 1602 or may be pre-configured within STA 1602.

In an embodiment, as described above, the condition for transmission of a PPDU to STA 1604 via a channel other than the first channel, during the period of unavailability of STA 1604 (or while STA 1604 is in limited/reduced/adaptive availability/operation), may be based on the type of the communication event occurring during the IDC event (to which the period of unavailability of STA 1604 is due). Returning to example 1600, after transmitting frame 1610, STA 1604 may exchange one or more frames (not shown in FIG. 16) with STA 1602. For example, STA 1604 may communicate with STA 1602 to transmit and/or receive data to/from STA 1602.

Subsequently, the period of unavailability (or limited/reduced/adaptive availability/operation) of STA 1604 begins. In example 1600, after the period of unavailability (or limited/reduced/adaptive availability/operation) of STA 1604 begins, data for STA 1604 with a TID equal to TID x (e.g., non-LL) arrives at STA 1602. In an embodiment, the condition for transmitting a PPDU via the second channel (e.g., CH2) to STA 1604, during the period of unavailability of STA 1604 (or while STA 1604 is in limited/reduced/adaptive availability/operation), may comprise, if the communication event (occurring during the IDC event) is a reception event, the PPDU comprising a data frame with TID y (e.g., LL). That is, only LL traffic may be transmitted to STA 1604 over the second channel if the communication event (occurring during the IDC event) is a reception event. As such, based on the data arriving for STA 1604 being of TID x (non-LL) and the communication (occurring during the IDC event) being a reception event, STA 1602 may determine that STA 1602 may not transmit the data via the second channel during the period of unavailability of STA 1604 (or while STA 1604 is in limited/reduced/adaptive availability/operation). Instead, STA 1602 may wait until the end of the period of unavailability (or limited/reduced/adaptive availability/operation) of STA 1604 and may transmit to STA 1604, after the period of unavailability (or limited/reduced/adaptive availability/operation) of STA 1604, a PPDU 1612 comprising the data with TID x. In an embodiment, as shown in FIG. 16, STA 1602 may transmit PPDU 1612 via the first channel (e.g., CH1). Alternatively, STA 1602 may transmit PPDU 1612 via the second channel (e.g., CH2).

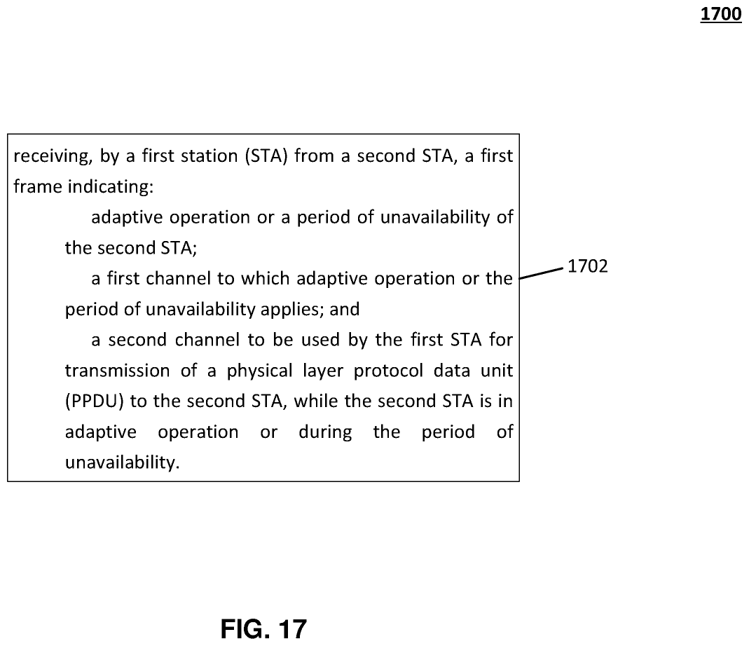

FIG. 17 illustrates an example process 1700 according to an embodiment. Example process 1700 is provided for the purpose of illustration only and is not limiting. Example process 1700 may be performed by a first STA, such as STA 1102, STA 1202, STA 1302, STA 1402, STA 1502, or STA 1602, for example. In an embodiment, the first STA may be an AP STA or a non-AP STA.

As shown in FIG. 17, process 1700 may include a step 1702, which includes receiving, by the first STA from a second STA, a first frame. The second STA may be similar to STA 1104, STA 1204, STA 1304, STA 1404, STA 1504, or STA 1604, for example. In an embodiment, the second STA may be an AP STA or a non-AP STA. In an embodiment, the first STA may be an AP STA, and the second STA may be a non-AP STA. The second STA may be associated with the first STA.

The first frame may comprise an ICF, an ICR, a request frame, a response frame, a control frame, a management frame, an action frame, a QoS null frame, or a QoS data frame, for example. In an embodiment, the first frame comprises an ICR transmitted by the second STA in response to an ICF frame from the first STA. In an embodiment, the ICR transmitted by the second STA comprises a multi-STA BlockAck frame, and the ICF transmitted by the first STA comprises a BSRP Trigger frame. In an embodiment, the first STA transmits the ICF to initiate frame exchanges (that are neither group addressed Data nor group address Management frames) with the second STA when the second STA operates in a mode in which the second STA may inform another STA of its limited/reduced/adaptive availability/operation (e.g., Dynamic Unavailability Operation (DUO) mode, Periodic Unavailability Operation (PUO) mode, or Limited Operation Mode (LOM)). LOM may also be referred to as Adaptive Operation Mode (AOM). In LOM/AOM, a STA may reduce/adapt (or may request from an associated AP to reduce/adapt) parameters used for communication (transmission/reception) with the STA. In another embodiment, where the second STA is a TXOP holder, the first frame comprises a BSRP Trigger frame.

In an embodiment, the first frame may indicate a period of unavailability (or limited/reduced/adaptive availability/operation) of the second STA. The period of unavailability (or limited/reduced/adaptive availability/operation) may be periodic or aperiodic. In an embodiment, the first frame indicates a start time and a duration for the period of unavailability (or limited/reduced/adaptive availability/operation). In an embodiment, the first frame may further indicate a first channel, e.g., to which the period of unavailability (or limited/reduced/adaptive availability/operation) applies. In an embodiment, the first channel is disabled/punctured during the period of unavailability or when the second STA operates in limited/reduced/adaptive availability/operation mode. In an embodiment, the first frame may further indicate a second channel to be used or that may be used by the first STA for transmission of a physical layer protocol data unit (PPDU) to the second STA, during the period of unavailability (or while the second STA is in limited/reduced/adaptive availability/operation). In an embodiment, the first frame indicates whether one or more channels that fall within a BSS bandwidth of the BSS of the second STA are enabled or disabled when the second STA operates in limited/reduced/adaptive availability/operation mode. In an embodiment, the first frame includes a channel bitmap with a respective bit for each channel indicating whether the channel is enabled/disabled when the second STA operates in limited/reduced/adaptive availability/operation mode.

In an embodiment, the period of unavailability (or limited/reduced/adaptive availability/operation) may be due to an IDC event at the second STA.

In an embodiment, the first frame may further indicate a condition for transmission (e.g., by the first STA) of a PPDU to the second STA during the period of unavailability of the second STA (or while the second STA is in limited/reduced/adaptive availability/operation).

In an embodiment, the first channel may comprise a primary channel of the second STA.

In an embodiment, the primary channel may comprise a 20 MHz primary channel, a 40 MHz primary channel, an 80 MHz primary channel, or a 160 MHz primary channel.

In an embodiment, the second channel may comprise a secondary channel of the second STA.

In an embodiment, the secondary channel may comprise a 20 MHz secondary channel, a 40 MHz secondary channel, an 80 MHz secondary channel, or a 160 MHz secondary channel.

In an embodiment, the first channel and the second channel may be adjacent channels.

In an embodiment, the first channel and the second channel may be non-adjacent channels.

In an embodiment, the first channel and the second channel may be overlapping channels.

In an embodiment, the condition may comprise the PPDU comprising a data frame with a TID equal to a first TID or with an AC equal to a first AC. In an embodiment, the first TID or the first AC may correspond to low-latency traffic or to urgent traffic, for example. In an embodiment, the first TID or the first AC may correspond to traffic that the second STA wants to receive during the period of unavailability of the second STA (or while the second STA is in limited/reduced/adaptive availability/operation).

In an embodiment, the first frame comprises a first field indicating the first TID or the first AC. In an embodiment, the first field indicates the first TID. As such, the first field may comprise a TID bitmap comprising a first bit corresponding to the first TID. In another embodiment, the first field indicates the first AC. As such, the first field may comprise an AC bitmap comprising a first bit corresponding to the first AC. In an embodiment, the first AC comprises AC_VO, AC_VI, AC_BE, or AC_BK.

In another embodiment, the condition may, additionally or alternatively, comprise the PPDU having a size/duration smaller than or equal to a threshold. In an embodiment, the first frame comprises a second field indicating the threshold or a maximum size/duration of the PPDU.

In a further embodiment, the condition may, additionally or alternatively, comprise the first STA not exceeding a total number of PPDUs that the first STA is allowed to transmit to the second STA during the period of unavailability (or limited/reduced/adaptive availability/operation). In an embodiment, the first frame comprises a third field indicating a total number of PPDUs that the first STA is allowed to transmit to the second STA during the period of unavailability of the second STA (or while the second STA is in limited/reduced/adaptive availability/operation).

In a further embodiment, the condition may, additionally or alternatively, comprise the first STA not exceeding a total number of PPDUs that the first STA is allowed to transmit to the second STA during the period of unavailability of the second STA (or while the second STA is in limited/reduced/adaptive availability/operation). In an embodiment, the first frame comprises a fourth field indicating a total number of PPDU fragments that the first STA is allowed to transmit to the second STA during the period of unavailability of the second STA (or while the second STA is in limited/reduced/adaptive availability/operation).

In a further embodiment, the condition may, additionally or alternatively, comprise the first STA not exceeding a total amount of traffic that the first STA is allowed to transmit to the second STA during the period of unavailability of the second STA (or while the second STA is in limited/reduced/adaptive availability/operation). In an embodiment, the first frame comprises a fifth field indicating an amount of traffic that the first STA is allowed to transmit to the second STA during the period of unavailability of the second STA (or while the second STA is in limited/reduced/adaptive availability/operation).

In a further embodiment, the condition may, additionally or alternatively, comprise the PPDU comprising a frame of a first frame type. In an embodiment, the first frame comprises a first field indicating the first frame type. In an embodiment, the first frame type may comprise an ICF, an ICR, an RTS frame, a CTS frame, an MU-RTS frame, a BSRP trigger frame, a BAR frame, a BA frame, a BSR frame, a control frame, or an action frame, for example. In an embodiment, the frame of the first frame type indicates that the first STA has buffered traffic for the second STA. In an embodiment, the frame of the first frame type further indicates a traffic type or an AC of the buffered traffic.

In a further embodiment, the condition may be based on the position of the second channel relative to the first channel.

In an embodiment, where the condition comprises the PPDU comprising a data frame with a traffic identifier (TID) equal to a first TID and where the second channel is adjacent/overlapping to the first channel, the first TID may be associated with low latency (LL) traffic.

In another embodiment, where the condition comprises the PPDU comprising a data frame with an access category (AC) equal to a first AC and where the second channel is adjacent to the first channel, the first AC may comprise AC_VO and AC_VI.

In an embodiment, where the condition comprises the PPDU comprising a data frame with a traffic identifier (TID) equal to a first TID and where the second channel is non-adjacent to the first channel, the first TID may be associated with non-low latency (non-LL) traffic.

In an embodiment, where the condition comprises the PPDU comprising a data frame with an access category (AC) equal to a first AC and where the second channel is non-adjacent to the first channel, the first AC comprises AC_BE, or AC_BK.

In an embodiment, where the condition comprises the PPDU having a size/duration smaller than or equal to a threshold, the threshold may be equal to a first threshold based on the second channel being adjacent/overlapping to the first channel.

In an embodiment, where the condition comprises the PPDU having a size/duration smaller than or equal to a threshold, the threshold may be equal to a second threshold based on the second channel being non-adjacent to the first channel.

In an embodiment, where the condition comprises the PPDU having a size/duration smaller than or equal to a threshold, the threshold may be greater than a second threshold based on the second channel being non-adjacent to the first channel.

In an embodiment, the condition comprises the PPDU comprising a frame of a first frame type. The first frame type may comprise an initial control frame (ICF), an initial control response frame (ICR), a request-to-send (RTS) frame, a clear-to-send (CTS) frame, a multi-user (MU)-RTS frame, a buffer status report poll (BSRP) trigger frame, a block ack request (BAR) frame, a block ack (BA) frame, a buffer status report (BSR) frame, a control frame or an action frame.

In an embodiment, the period of the unavailability of the second STA may be caused by a communication event associated with another RAT. In an embodiment, the condition is based on a type of the other RAT. The other RAT may comprise Bluetooth®, Lightwave communication, 5G/6G, Ultrawideband (UWB), etc. In an embodiment, the condition comprises the PPDU comprising a data frame with a traffic identifier (TID) equal to a first TID or with an access category (AC) equal to a first AC. The first TID/AC may vary based on the type of the other RAT. In an embodiment, the condition comprises the PPDU having a size/duration smaller than or equal to a threshold. The threshold may vary based on the type of the other RAT. In an embodiment, the condition comprises the PPDU comprising a frame of a first frame type. The first frame type may vary based on the type of the other RAT.

In an embodiment, the period of the unavailability (or limited/reduced/adaptive availability/operation) of the second STA may be caused by a communication event associated with another radio access technology (RAT). In an embodiment, the condition is based on a type of the communication event. The communication event may comprise a transmission event or a reception event. In an embodiment, the condition comprises the PPDU comprising a data frame with a traffic identifier (TID) equal to a first TID or with an access category (AC) equal to a first AC. The first TID/AC may vary based on the type of the communication event. In an embodiment, the condition comprises the PPDU having a size/duration smaller than or equal to a threshold. The threshold may vary based on the type of the communication event. In an embodiment, the condition comprises the PPDU comprising a frame of a first frame type. The first frame type may vary based on the type of the communication event.

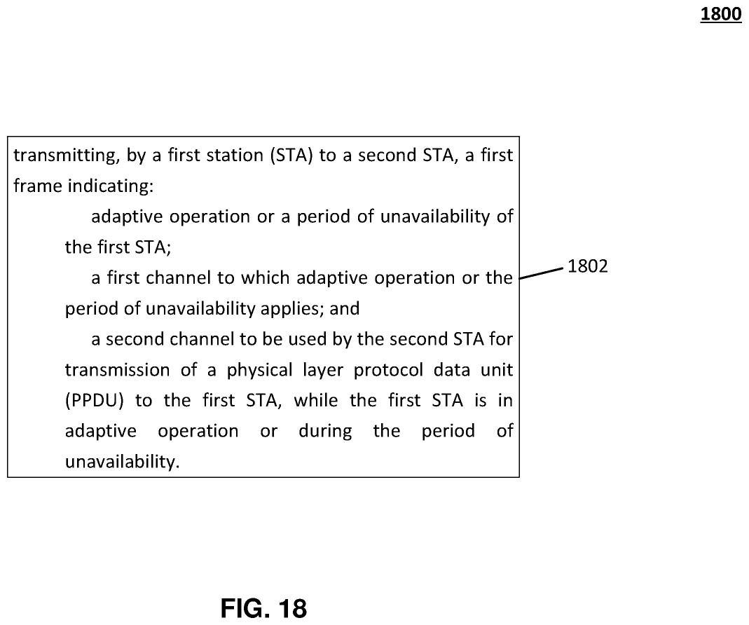

FIG. 18 illustrates an example process 1800 according to an embodiment. Example process 1800 is provided for the purpose of illustration only and is not limiting. Example process 1800 may be performed by a first STA, such as STA 1104, STA 1204, STA 1304, STA 1404, STA 1504, or STA 1604, for example. In an embodiment, the first STA may be an AP STA or a non-AP STA.

As shown in FIG. 18, process 1800 may include a step 1802, which includes transmitting, by the first STA to a second STA, a first frame. The second STA may be similar to STA 1102, STA 1202, STA 1302, STA 1402, STA 1502, or STA 1602, for example. In an embodiment, the second STA may be an AP STA or a non-AP STA. In an embodiment, the first STA may be an AP STA, and the second STA may be a non-AP STA. The first STA may be associated with the second STA.

The first frame may comprise an ICF, an ICR, a request frame, a response frame, a control frame, a management frame, an action frame, a QoS null frame, or a QoS data frame, for example. In an embodiment, the first frame comprises an ICR transmitted by the first STA in response to an ICF frame from the second STA. In an embodiment, the ICR transmitted by the first STA comprises a multi-STA BlockAck frame, and the ICF transmitted by the second STA comprises a BSRP Trigger frame. In an embodiment, the second STA transmits the ICF to initiate frame exchanges (that are neither group addressed Data nor group address Management frames) with the first STA when the first STA operates in a mode in which the first STA may inform another STA of its limited/reduced/adaptive availability/operation (e.g., Dynamic Unavailability Operation (DUO) mode, Periodic Unavailability Operation (PUO) mode, or Limited Operation Mode (LOM). LOM may also be referred to as Adaptive Operation Mode (AOM). In LOM/AOM, a STA may reduce/adapt (or may request from an associated AP to reduce/adapt) parameters used for communication (transmission/reception) with the STA. In another embodiment, where the first STA is a TXOP holder, the first frame comprises a BSRP Trigger frame.

In an embodiment, the first frame may indicate a period of unavailability (or limited/reduced/adaptive availability/operation) of the first STA. The period of unavailability (or limited/reduced/adaptive availability/operation) may be periodic or aperiodic. In an embodiment, the first frame indicates a start time and a duration for the period of unavailability (or limited/reduced/adaptive availability/operation). In an embodiment, the first frame may further indicate a first channel, e.g., to which the period of unavailability (or limited/reduced/adaptive availability/operation) applies. In an embodiment, the first frame may further indicate a second channel to be used or that may be used by the second STA for transmission of a physical layer protocol data unit (PPDU) to the first STA, during the period of unavailability of the first STA (or while the first STA is in limited/reduced/adaptive availability/operation). In an embodiment, the first frame indicates whether one or more channels that fall within a BSS bandwidth of the BSS of the first STA are enabled or disabled when the first STA operates in limited/reduced/adaptive availability/operation mode. In an embodiment, the first frame includes a channel bitmap with a respective bit for each channel indicating whether the channel is enabled/disabled when the first STA operates in limited/reduced/adaptive availability/operation mode.

In an embodiment, the period of unavailability (or limited/reduced/adaptive availability/operation) may be due to an IDC event at the first STA.

In an embodiment, the first frame may further indicate a condition for transmission (e.g., by the second STA) of a PPDU to the first STA during the period of unavailability of the first STA (or while the first STA is in limited/reduced/adaptive availability/operation).

In an embodiment, the first channel may comprise a primary channel of the first STA.

In an embodiment, the primary channel may comprise a 20 MHz primary channel, a 40 MHz primary channel, an 80 MHz primary channel, or a 160 MHz primary channel.

In an embodiment, the second channel may comprise a secondary channel of the first STA.

In an embodiment, the secondary channel may comprise a 20 MHz secondary channel, a 40 MHz secondary channel, an 80 MHz secondary channel, or a 160 MHz secondary channel.

In an embodiment, the first channel and the second channel may be adjacent channels.

In an embodiment, the first channel and the second channel may be non-adjacent channels.

In an embodiment, the first channel and the second channel may be overlapping channels.

In an embodiment, the condition may comprise the PPDU comprising a data frame with a TID equal to a first TID or with an AC equal to a first AC. In an embodiment, the first TID or the first AC may correspond to low-latency traffic or to urgent traffic, for example. In an embodiment, the first TID or the first AC may correspond to traffic that the first STA wants to receive during the period of unavailability of the first STA (or while the first STA is in limited/reduced/adaptive availability/operation).

In an embodiment, the first frame comprises a first field indicating the first TID or the first AC. In an embodiment, the first field indicates the first TID. As such, the first field may comprise a TID bitmap comprising a first bit corresponding to the first TID. In another embodiment, the first field indicates the first AC. As such, the first field may comprise an AC bitmap comprising a first bit corresponding to the first AC. In an embodiment, the first AC comprises AC_VO, AC_VI, AC_BE, or AC_BK.

In another embodiment, the condition may, additionally or alternatively, comprise the PPDU having a size/duration smaller than or equal to a threshold. In an embodiment, the first frame comprises a second field indicating the threshold or a maximum size/duration of the PPDU.

In a further embodiment, the condition may, additionally or alternatively, comprise the second STA not exceeding a total number of PPDUs that the second STA is allowed to transmit to the first STA during the period of unavailability of the first STA (or while the first STA is in limited/reduced/adaptive availability/operation). In an embodiment, the first frame comprises a third field indicating a total number of PPDUs that the second STA is allowed to transmit to the first STA during the period of unavailability of the first STA (or while the first STA is in limited/reduced/adaptive availability/operation).

In a further embodiment, the condition may, additionally or alternatively, comprise the second STA not exceeding a total number of PPDUs that the second STA is allowed to transmit to the first STA during the period of unavailability of the first STA (or while the first STA is in limited/reduced/adaptive availability/operation). In an embodiment, the first frame comprises a fourth field indicating a total number of PPDU fragments that the second STA is allowed to transmit to the first STA during the period of unavailability of the first STA (or while the first STA is in limited/reduced/adaptive availability/operation).

In a further embodiment, the condition may, additionally or alternatively, comprise the second STA not exceeding a total amount of traffic that the second STA is allowed to transmit to the first STA during the period of unavailability of the first STA (or while the first STA is in limited/reduced/adaptive availability/operation). In an embodiment, the first frame comprises a fifth field indicating an amount of traffic that the second STA is allowed to transmit to the first STA during the period of unavailability of the first STA (or while the first STA is in limited/reduced/adaptive availability/operation).

In a further embodiment, the condition may, additionally or alternatively, comprise the PPDU comprising a frame of a first frame type. In an embodiment, the first frame comprises a first field indicating the first frame type. In an embodiment, the first frame type may comprise an ICF, an ICR, an RTS frame, a CTS frame, an MU-RTS frame, a BSRP trigger frame, a BAR frame, a BA frame, a BSR frame, a control frame, or an action frame, for example. In an embodiment, the frame of the first frame type indicates that the second STA has buffered traffic for the first STA. In an embodiment, the frame of the first frame type further indicates a traffic type or an AC of the buffered traffic.

In a further embodiment, the condition may be based on the position of the second channel relative to the first channel.

In an embodiment, where the condition comprises the PPDU comprising a data frame with a traffic identifier (TID) equal to a first TID and where the second channel is adjacent/overlapping to the first channel, the first TID may be associated with low latency (LL) traffic.

In another embodiment, where the condition comprises the PPDU comprising a data frame with an access category (AC) equal to a first AC and where the second channel is adjacent to the first channel, the first AC may comprise AC_VO and AC_VI.

In an embodiment, where the condition comprises the PPDU comprising a data frame with a traffic identifier (TID) equal to a first TID and where the second channel is non-adjacent to the first channel, the first TID may be associated with non-low latency (non-LL) traffic.

In an embodiment, where the condition comprises the PPDU comprising a data frame with an access category (AC) equal to a first AC and where the second channel is non-adjacent to the first channel, the first AC comprises AC_BE, or AC_BK.

In an embodiment, where the condition comprises the PPDU having a size/duration smaller than or equal to a threshold, the threshold may be equal to a first threshold based on the second channel being adjacent/overlapping to the first channel.

In an embodiment, where the condition comprises the PPDU having a size/duration smaller than or equal to a threshold, the threshold may be equal to a second threshold based on the second channel being non-adjacent to the first channel.

In an embodiment, where the condition comprises the PPDU having a size/duration smaller than or equal to a threshold, the threshold may be greater than a second threshold based on the second channel being non-adjacent to the first channel.

In an embodiment, the condition comprises the PPDU comprising a frame of a first frame type. The first frame type may comprise an initial control frame (ICF), an initial control response frame (ICR), a request-to-send (RTS) frame, a clear-to-send (CTS) frame, a multi-user (MU)-RTS frame, a buffer status report poll (BSRP) trigger frame, a block ack request (BAR) frame, a block ack (BA) frame, a buffer status report (BSR) frame, a control frame or an action frame.

In an embodiment, the period of the unavailability of the first STA may be caused by a communication event associated with another RAT. In an embodiment, the condition is based on a type of the other RAT. The other RAT may comprise Bluetooth®, Lightwave communication, 5G/6G, Ultrawideband (UWB), etc. In an embodiment, the condition comprises the PPDU comprising a data frame with a traffic identifier (TID) equal to a first TID or with an access category (AC) equal to a first AC. The first TID/AC may vary based on the type of the other RAT. In an embodiment, the condition comprises the PPDU having a size/duration smaller than or equal to a threshold. The threshold may vary based on the type of the other RAT. In an embodiment, the condition comprises the PPDU comprising a frame of a first frame type. The first frame type may vary based on the type of the other RAT.

In an embodiment, the period of the unavailability of the first STA may be caused by a communication event associated with another radio access technology (RAT). In an embodiment, the condition is based on a type of the communication event. The communication event may comprise a transmission event or a reception event. In an embodiment, the condition comprises the PPDU comprising a data frame with a traffic identifier (TID) equal to a first TID or with an access category (AC) equal to a first AC. The first TID/AC may vary based on the type of the communication event. In an embodiment, the condition comprises the PPDU having a size/duration smaller than or equal to a threshold. The threshold may vary based on the type of the communication event. In an embodiment, the condition comprises the PPDU comprising a frame of a first frame type. The first frame type may vary based on the type of the communication event.

What is claimed is:

1. A first station (STA) comprising:
one or more processors; and
memory storing instructions that, when executed by the one or more processors, cause the first STA to:
receive, from a second STA, a first frame indicating:
an adaptive operation mode of the second STA, wherein in the adaptive operation mode the second STA is capable of adapting parameters used for communication with the second STA;
a first channel, wherein the first channel is disabled while the second STA is in the adaptive operation mode; and
a second channel to be used by the first STA for transmission of a physical layer protocol data unit (PPDU) to the second STA while the second STA is in the adaptive operation mode.

2. The first STA of claim 1, wherein the first STA comprises an access point (AP) STA.

3. The first STA of claim 1, wherein the second STA comprises a non-access point (non-AP) STA.

4. The first STA of claim 1, wherein the instructions, when executed by the one or more processors, further cause the first STA to transmit, to the second STA, while the second STA is in the adaptive operation mode and via the second channel, a first physical layer protocol data unit (PPDU).

5. The first STA of claim 1, wherein the first frame further indicates a condition for transmission of a PPDU, while the second STA is in the adaptive operation mode and via the second channel, to the second STA.

6. The first STA of claim 5, wherein the condition comprises the PPDU having a size smaller than or equal to a threshold.

7. The first STA of claim 1, wherein the first frame includes a channel bitmap with a respective bit for each channel, among the first channel and the second channel, indicating whether the channel is enabled or disabled when the second STA operates in the adaptive operation mode.

8. A first station (STA) comprising:
one or more processors; and
memory storing instructions that, when executed by the one or more processors, cause the first STA to:
transmit, to a second STA, a first frame indicating:
an adaptive operation mode of the first STA, wherein in the adaptive operation mode the first STA is capable of adapting parameters used for communication with the first STA;
a first channel, wherein the first channel is disabled while the first STA is in the adaptive operation mode; and
a second channel to be used by the second STA for transmission of a physical layer protocol data unit (PPDU) to the first STA while the first STA is in the adaptive operation mode.

9. The first STA of claim 8, wherein the second STA comprises an access point (AP) STA.

10. The first STA of claim 8, wherein the first STA comprises a non-access point (non-AP) STA.

11. The first STA of claim 8, wherein the instructions, when executed by the one or more processors, further cause the first STA to receive, from the second STA, while the first STA is in the adaptive operation mode and via the second channel, a first physical layer protocol data unit (PPDU).

12. The first STA of claim 8, wherein the first frame further indicates a condition for transmission of a PPDU, via the second channel, to the first STA while the first STA is in the adaptive operation mode.

13. The first STA of claim 12, wherein the condition comprises the PPDU having a size smaller than or equal to a threshold.

14. The first STA of claim 8, wherein the first frame includes a channel bitmap with a respective bit for each channel, among the first channel and the second channel, indicating whether the channel is enabled or disabled when the first STA operates in the adaptive operation mode.

15. A non-transitory computer-readable medium storing instructions that, when executed by one or more processors of a first station (STA), cause the first STA to:
receive, from a second STA, a first frame indicating:
an adaptive operation mode of the second STA, wherein in the adaptive operation mode the second STA is capable of adapting parameters used for communication with the second STA;
a first channel, wherein the first channel is disabled while the second STA is in the adaptive operation mode; and
a second channel to be used by the first STA for transmission of a physical layer protocol data unit (PPDU) to the second STA while the second STA is in the adaptive operation mode.

16. The non-transitory computer-readable medium of claim 15, wherein the first STA comprises an access point (AP) STA.

17. The non-transitory computer-readable medium of claim 15, wherein the second STA comprises a non-access point (non-AP) STA.

18. The non-transitory computer-readable medium of claim 15, wherein the instructions, when executed by the one or more processors, further cause the first STA to transmit, to the second STA, while the second STA is in the adaptive operation mode and via the second channel, a first physical layer protocol data unit (PPDU).

19. The non-transitory computer-readable medium of claim 15, wherein the first frame further indicates a condition for transmission of a PPDU, while the second STA is in the adaptive operation mode and via the second channel, to the second STA, and wherein the condition comprises the PPDU having a size smaller than or equal to a threshold.

20. The non-transitory computer-readable medium of claim 15, wherein the first frame includes a channel bitmap with a respective bit for each channel, among the first channel and the second channel, indicating whether the channel is enabled or disabled when the second STA operates in the adaptive operation mode.
